(19) United States
(12) Patent Application Publication
(10) Pub. No.: US 2009/0070128 A1
(43) Pub. Date: Mar. 12, 2009

(54) Community-based community project content creation system and method

(75) Inventors: David Bruce McCauley, Greenwood, IN (US); Sandra Powell, Bloomington, IN (US); Benjamin Wm. Cram, Bloomington, IN (US); Nathan Paul Williamson, Linton, IN (US); Jacob Leon Geib-Rosch, Indianapolis, IN (US); Kenneth J. Kratz, Yorktown, IN (US); James Thomas Stanley, Fishers, IN (US); Christopher Lawrence Yates, Indianapolis, IN (US)

Correspondence Address: Raj Abhyanker LLP;c/o Intellevate, P.O. Box 52050, Minneapolis, MN, 55402, US

(73) Assignee: Author Solutions Inc.

(21) Appl. No.: 11/900,481

(22) Filed: Sep. 11, 2007

(51) Int. Cl. G06Q 90/00

(52) U.S. Cl. 705/1

(57) ABSTRACT

A method and system of community-based project content creation are disclosed. In one embodiment, a method includes generating user profiles, associating first user with a first user profile, generating project profiles, each project profile associated with at least one user profile, associating the first user with a first project profile, designating a privilege level associated with a second user profile, and generating as online project collaboration between the first project profile and the second user profile based on the privilege level. The method may also include generating community building activities. The method may also include personalizing the first user profile. The method may further include generating a search associated with the user profiles and/or the project profiles. In addition, the method may include generating a post-publishing activity associated.

### FIELD OF TECHNOLOGY

This disclosure relates generally to the technical field of communications and, in one example embodiment, to a method and system of a community-based project content creation.

### BACKGROUND

Works of authorship may bring books, films, and other creative projects to the public. Such works may spring from a seed of creativity. The works, however, may take months or even years to complete. An author of the work may have to invest inordinate amounts of time into the project to complete it.

Alternatively, the author may seek contributions to works in progress. Locating qualified contributors may be difficult. Managing content contributions and edits of works may also be difficult. Once a work is completed, the author may have difficulty publishing, marketing, and distributing the completed work.

### SUMMARY

A method and system of community-based project content creation are disclosed. In one aspect, a method includes generating user profiles, associating a first user with a first user profile, generating project profiles, each project profile associated with at least one user profile, associating the first user with a first project profile, designating a privilege level associated with a second user profile, and generating an online project collaboration (e.g., may include interacting via a wiki) between the first project profile and the second user profile based on the privilege level.

The online project collaboration may include contributing material to a first project (e.g., may include a book, a magazine, audio books, an advertising copy, a screenplay, a periodical, music, video, and/or a music sound file, etc.) associated with the first project profile, editing a portion of the first project (e.g., may include a section, a chapter, cited material, and/or quoted material, etc.) associated with the first project profile, displaying a portion of the first project according to a predetermined structure, locking a portion of the first project associated with the first project profile, tracking information associated with the contributed material, and controlling revisions to the first project.

The controlling revisions to the first project may include archiving at least one version of the first project, displaying at least two versions of the first project, identifying differences between the two versions of the first project, and generating a previous version of the first project by reversing edits to a current version of the first project. The online project collaboration may further include a discussion associated with a user profile and/or a project profile, generating a forum to display comments associated with the user profiles and the project profiles, messaging associated with a portion of the user profiles, manage the online project collaboration, managing partner related activities, and/or chatting associated with a portion of the user profiles.

The method may further include generating community building activities. The generating community building activities may include generating tags associated with interest categories, generating topics associated with the project profiles, rating a project associated with a project profile, generating feedback related to a user associated with a user profile, and generating feedback related to a project associated with a project profile.

The method may also include personalizing the first user profile. The personalizing the first user profile may include associating at least one user profile with the first user profile to create a friends network, blocking at least one user profile, generating a list of favorite projects, each favorite project associated with a corresponding project profile, managing colors and font styles of the community environment, and/or controlling a location of a navigational item associated with the first user profile and/or the first project profile.

The method may further include generating a search associated with the user profiles and/or the project profiles. The generating a search may include searching tags associated with interest categories, searching a portion of the user profiles and a portion of the project profiles in full text mode, and searching the project profiles based on a topic and/or a genre. The privilege level may include role-based privilege levels, project-based privilege level, and/or profile-based privilege levels. The role-based privilege levels may further include a reader level, a contributor level, an editor level, and/or a coeditor level. The project-based privilege level may include a public level, a private level, and/or a prohibited content level. The profile-based privilege levels may include a prohibited user profile level.

The method may further include generating a post-publishing activity associated with a second project profile. The generating post-publishing activity may include generating a price related to a second project associated with the second project profile, determining marketing preferences associated with the second project, generating customized author pages associated with the second project, generating orders associated with the second project, managing royalties associated with the second project, managing sales activities associated with the second project, tracking a status associated with the second project, generating an alert and/or a notification associated with the second project, generating at least one website to promote the second project, and/or generating a communication associated with the second project.

In another aspect, a system includes a community environment, a community network module of the community environment, the community network module to include user profiles and project profiles, each project profile associated with at least one user profile and a project. For example, the project may include a book (e.g., may include a section, a chapter, cited material, and/or a quoted material, etc.), a magazine, audio books, an advertising copy, a screenplay, a periodical, music, video, and/or a music sound file.

The system also includes a privilege level module to designate at least one privilege level associated with a first project profile associated with a first user profile to a second user profile, and an online project collaboration module to generate an online project collaboration (e.g., may include interacting via a wiki) between a first project and the second user profile.

The privilege level module may include a role-based module to designate role-based privilege levels (e.g., a reader level, a contributor level, an editor level, and/or a coeditor level, etc.), a project-based module may designate a project based privilege level (e.g., a public level, a private level and/or a prohibited content level, etc.), a profile-based module may designate a profile-based privilege level (e.g., a prohibited user profile level).

The online project collaboration module may also include a contribution module to contribute material to the first project associated with the first project profile, an edit module to edit a portion of the first project associated with the first project profile, a display module to display a portion of the first project according to a predetermined structure, a lock module to lock a portion of the first project associated with the first project profile, a track module to track information associated with the contributed material, and a revision control module to control revisions to the first project.

The revision control module may include an archive module to archive at least one version of the first project, a comparison module to display at least two versions of the first project and to identify differences between the two versions, and/or an undo edits module to generate a previous version of the first project by reversing edits to a current version of the first project.

The online project collaboration may further include a discussion module to enable a discussion associated with a user profile and/or a project profile, a forum module to generate a forum to display comments associated with the user profiles and the project profiles, a messaging module to enable messaging associated with the a portion of the user profiles, an administration module to manage online project collaboration, and a partnership module to manage partner-related activities, and/or a chat module to enable chatting associated with the a portion of the user profiles.

The system may further include a community building module to generate community building activities, a user profile module to generate personalized user profiles, a search module to generate a search associated with the user profiles and/or the project profiles, and/or a post-publishing module to generate post-publishing activities.

The community building module may further include a tag module to generate tags associated with interest categories, a topics module to generate topics associated with the project profiles, a project rating module to rate a project associated with a project profile, a user feedback module to generate feedback related to a user associated with a user profile, and/or a project feedback module to generate feedback related to a project associated with a project profile.

The user profile module may include a friends network module to associate at least one user profile with the first user profile, a blocked user profile module to block at least one user profile, a favorite projects module to generate a list of favorite projects, each favorite project associated with a corresponding project profile, a customize interface module to manage colors and font styles of a portion of the community environment, and/or a navigation module to control a location of a navigational item associated with a user profile and/or a project profile.

The search module may include a search tags module to search tags associated with interest categories, a search full text module to search a portion of the user profiles and a portion of the project profiles in full text mode, and/or a search topics module to search the project profiles based on a topic and/or a genre.

The post-publishing module may include a pricing module to generate a price related to a second project associated with a second project profile, a marketing module to determine marketing preferences associated with the second project, an author pages module to generate customized author pages associated with the second project, an ordering module to generate orders associated with the second project.

The post-publishing module may also include a royalties module to manage royalties associated with the second project, a sales activities module to manage sales activities associated with the second project, a tracking module to track a status associated with the second project, an alerts module to generate an alert and/or a notification associated with the second project, a website module to generate at least one website to promote the second project, and/or a communication module to generate a communication associated with the second project.

In yet another aspect, a community environment includes a first instruction set to enable a community network, to include a user database to include user profiles and a project database to include project profiles, each project profile associated with at least one user profile and a project, a second instruction set integrated with the first instruction set to generate privilege levels associated with the user profiles and the project profiles, and a third instruction set integrated with the first instruction set and the second instruction set to generate an online collaboration between a user profile and a project of a project profile.

In addition, the community environment may include a fourth instruction set intergrated with the first instruction set, the second instruction set and the third instruction set to generate a display associated with the online collaboration, the user profile, the project profile and/or the project.

The methods, system, and apparatuses disclosed herein may be implemented in any means for achieving various aspects, and may be executed in a form of a machine-readable medium embodying a set of instruction that, when executed by a machine, causes the machine to perform any of the operation disclosed herein. Other features will be apparent from the accompanying drawing and from the detailed description that follows.

### BRIEF DESCRIPTION OF THE DRAWINGS

Example embodiments are illustrated by way of example and not limitation in the figures of the accompanying drawings, in which like references indicate similar elements and in which:

FIG. 1 is a system view of a community environment enabling an online project collaboration between user profiles and project profiles, according to one embodiment.

FIG. 2 is an exploded view of the community network module of FIG. 1, according to one embodiment.

FIG. 3 is an exploded view of the additional modules of FIG. 1, according to one embodiment.

FIG. 4 is a block diagram illustrating generation of a display view, according to one embodiment.

FIG. 5 is a user interface view displaying a homepage associated with a website, according to one embodiment.

FIG. 6 is a user interface view displaying a login and sign up page associated with the website, according to one embodiment.

FIG. 7 is a user interface view of a webpage associated with a user, according to one embodiment.

FIG. 8 is a user interface view of creating a project profile, according to one embodiment.

FIG. 9 is a user interface view displaying the project profile, according to one embodiment.

FIG. 10A is a user interface view of showing content associated with a first project of the project profile, according to one embodiment.

FIG. 10B is a user interface view of editing the content associated with the first project of the project profile, according to one embodiment.

FIG. 11 is a user interface view displaying comments associated with the first project, according to one embodiment.

FIG. 12 is a user interface view displaying history associated with the first project, according to one embodiment.

FIG. 13 is a user interface view of rating contributors associated with the first project, according to one embodiment.

FIG. 14 is a user interface view of browsing projects, according to one embodiment.

FIG. 15 is a user interface view displaying a discussion associated with the first project, according to one embodiment.

FIG. 16 is a user interface view displaying a user profile, according to one embodiment.

FIG. 17 is a diagrammatic system view of a data processing system in which any of the embodiments disclosed herein may be performed, according to one embodiment.

FIG. 18 is a table view displaying privilege level(s) associated with the user profiles related to a project, according to one embodiment.

FIG. 19A is a process flow of generating an online project collaboration between the project profiles and the user profiles, according to one embodiment.

FIG. 19B is a continuation of the process flow of FIG. 19A illustrating additional process, according to one embodiment.

Other features of the present embodiments will be apparent from the accompanying drawings and from the detailed description that follows.

### DETAILED DESCRIPTION

A method and system of community-based project content creation are disclosed. In the following description, for the purposes of explanation, numerous specific details are set forth in order to provide a thorough understanding of the various embodiments. It will be evident, however to one skilled in the art that the various embodiments may be practiced without these specific details.

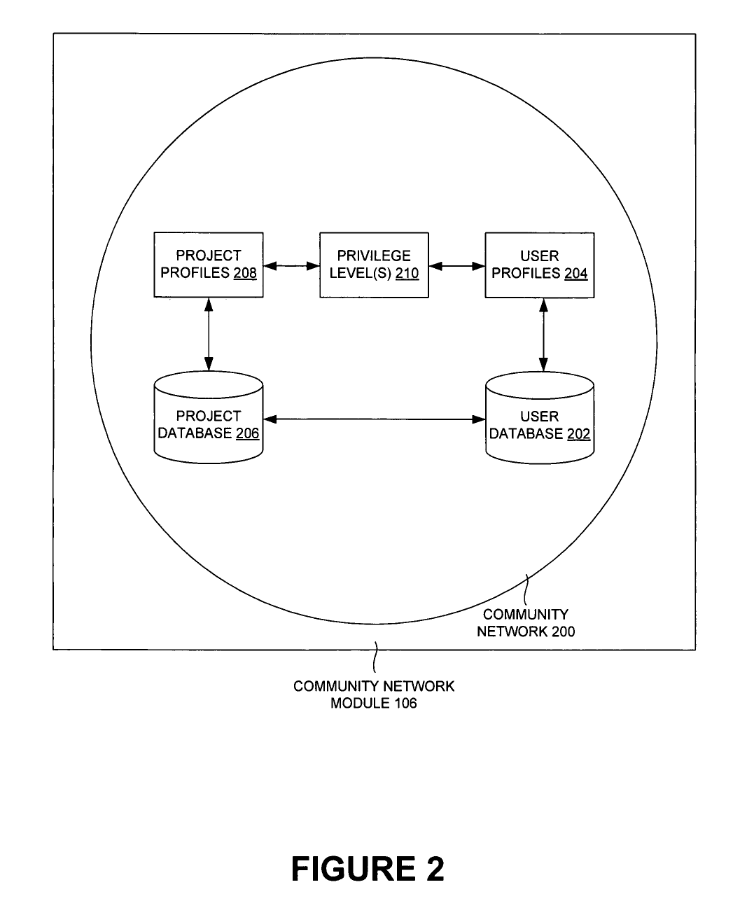

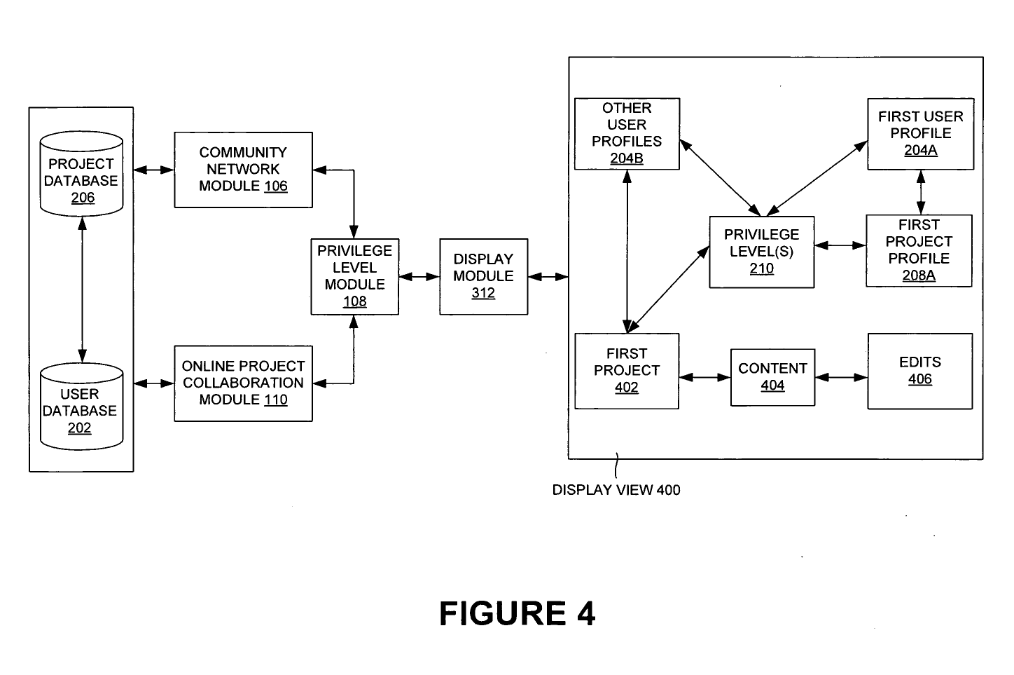

In one embodiment, a method includes generating user profiles (e.g., the user profiles 204 of FIG. 2), associating a first user with a first user profile (e.g., the first user profile 204A of FIG. 4), generating project profiles (e.g., the project profiles 208 of FIG. 2), each project profile 208 associated with a user profile (e.g., of the user profiles 204 of FIG. 2), associating the first user with a first project profile (e.g., the first project profile 208A of FIG. 2), designating a privilege level (e.g., the privilege level(s) 210 of FIG. 2) associated with a second user profile (e.g., of the other user profiles 204B of FIG. 4), and generating an online project collaboration between the first project profile 208A and the second user profile 204B based on the privilege level 210.

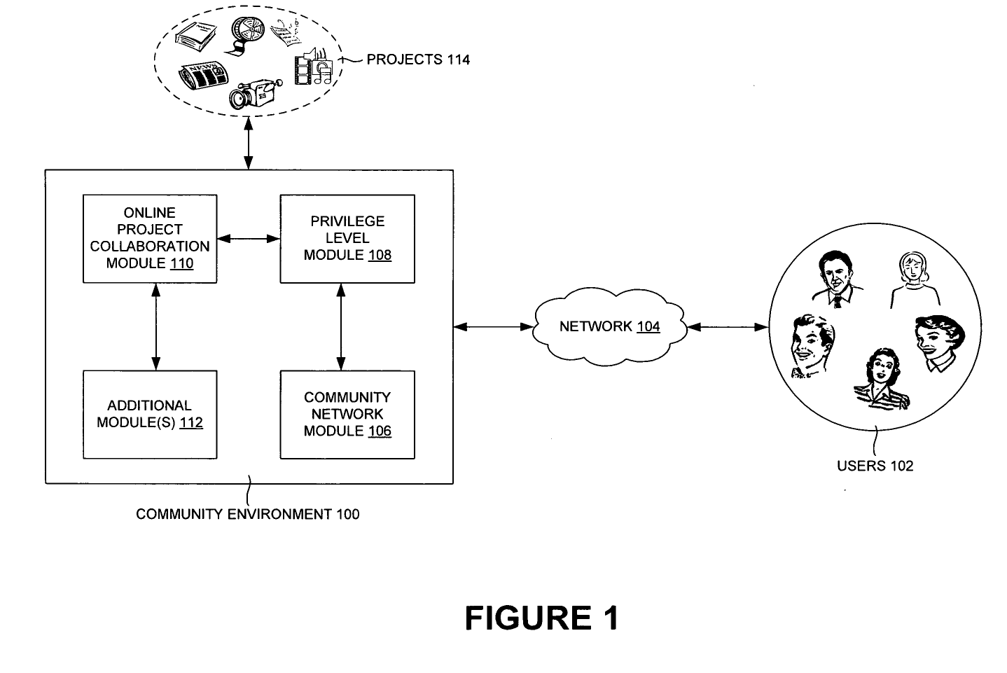

In another embodiment, a system includes a community environment (e.g., the community environment 100 of FIG. 1), a community network module (e.g., the community network module 106 of FIG. 1) of the community environment 100, the community network module 106 to include user profiles 204 and project profiles 208, each project profile 208 associated with a user profile 204 and a project (e.g., of the projects 114 of FIG. 1), a privilege level module (e.g., the privilege module 108 of FIG. 1) of the community environment 100 to designate a privilege level 210 associated with a first project profile 208A associated with a first user profile 204A to a second user profile (e.g., of the other user profiles 204B of FIG. 4), and an online project collaboration module (e.g., the online project collaboration module 110 of FIG. 1) of the community environment 100 to generate an online project collaboration between a first project (e.g., the first project 402 of FIG. 4) and the second user profile 204B.

In yet another embodiment, a community environment 100 includes a first instruction set to enable a community network 200, to include a user database (e.g., the user database 202 of FIG. 2) to include user profiles 204 and a project database (e.g., the project database 206 of FIG. 2) to include project profiles 208, each project profile 208 associated with a user profile (e.g., of the user profiles 204 of FIG. 2) and a project (e.g., of the projects 114 of FIG. 1), a second instruction set integrated with the first instruction set to generate privilege level(s) 210 (e.g., using the privilege level module 108 of FIG. 1) associated with the user profiles 204 and the project profiles 208, and a third instruction set integrated with the first instruction set and the second instruction set to generate an online collaboration (e.g., using the online project collaboration module 110 of FIG. 1) between a user profile 204 and a project 114 of a project profile 208.

FIG. 1 is a system view of a community environment 100 enabling an online project collaboration between user profiles (e.g., the user profiles 204 of FIG. 2) and project profiles (e.g., the project profiles 208 of FIG. 2), according to one embodiment. Particularly, FIG. 1 illustrates the community environment 100, users 102, a network 104, a community network module 106, a privilege level module 108, an online project collaboration module 110, additional module(s) 112 and projects 114, according to one embodiment.

The community environment 100 may enable creation of a community network (e.g., the community network 200 of FIG. 2) where an online community of users 102 (e.g., writers, editors and/or contributors, etc.) associated with the user profiles 204 collaborate to complete the projects 114 associated with the project profiles 208. For example, writers and editors may make their creative dreams a reality with the help of contributors and/or coeditors. For example, the contributors and the coeditors may be users 102 having interest in a project (e.g., of the projects 114 of FIG. 1) and willing to contribute for the project 114.

The users 102 may include registered users and/or unregistered users of the community environment 100. The registered users may be members having user profiles 204 in the community network 200. For example, the user profiles 204 may include information such as a name, address, contact information (e.g., phone number, email address, etc.), picture, and/or other biographical information (e.g., interests, contributions, life history, etc.). In one example embodiment, the unregistered users may be enabled to view and/or read the project profiles 208 whereas the registered users may be enabled to edit (e.g., update, modify and/or delete, etc.) content associated with the project profiles 208.

The network 104 may facilitate communication between the users 102 and the community environment 100. The community network module 106 may generate the community network 200 that includes the user profiles 204 and the project profiles 208 in the community environment 100. In one example embodiment, the project profiles 208 may be associated with the user profiles 204 and the projects 114. For example, the users 102 of the community environment 100 may form the community network 200 based on an online collaboration between the user profiles 204 and the project profiles 208.

The privilege level module 108 may designate privilege level(s) (e.g., the privilege level(s) 210 of FIG. 2) associated with a project profile 208 (e.g., associated with a user profile 204) to other user profiles 204 in the community network 200 based on interests specified in the other user profiles 204. For example, the privilege levels 210 may include role-based privilege levels (e.g., reader, contributor, and/or editor, etc.), a project-based privilege level (e.g., public or private, etc.) and/or a profile-based privilege level (e.g., prohibited user profile level).

The online project collaboration module 110 may generate an online project collaboration between the user profiles 204 and the projects 114 of the project profiles 208. For example, the online project collaboration may include contributing material, editing content, a discussion (e.g., discussion writing) and/or commenting associated with the project 114.

The additional module(s) 112 may generate additional processes to generate an online network of users 102 (e.g., writers, editors and/or contributors, etc.) where the users 102 can share thoughts and/or views associated with the project 114 in order to publish the project 114 (e.g., book, journal, periodical, etc.). The projects 114 may be a book, a magazine, audio books, an advertising copy, a screenplay, a periodical, music, video, and/or a music sound file which are further classified into sections, chapters, cited material and/or quoted material. For example, each project profile 208 may include a portion of project 114 which is completed based on the online collaboration of the users 102 based on the privilege level(s) 210 associated with each user 102.

For example, a project (e.g., of the projects 114 of FIG. 1) may be associated with a first user (e.g., of the users 102 of FIG. 1) having a user profile (e.g., of the user profiles 204 of FIG. 2). The first user 102 may invite other users 102 (e.g., associated with user profiles 204 in the community network 200) to contribute to the project 114 and may assign different privilege level(s) 210 based on interests of the other users 102. Further, the other users 102 may edit (e.g., modify, delete, etc.) content, post comments regarding the project 114 based on the privilege levels 210 assigned to each of the users 102. For example, a user may be allowed to post comments to the project 114 while another user may modify the content associated with the project 114 based on the assigned privilege level(s) 210. As a result, the first user 102 may complete the project 114 through contributions of the other users 102.

In the example embodiment illustrated in FIG. 1, the community environment 100 communicates with the users 102 through the network 104 (e.g., Internet). The community environment 100 also communicates with the projects 114 of the project profiles 208 associated with the user profiles 204. The community environment 100 includes the community network module 106, the privilege level module 108, the online project collaboration module 110 and the additional modules 112, interacting with each other.

In one embodiment, a first instruction set may enable a community network 200, to include a user database 202 to include user profiles 204 and a project database 206 to include project profiles 208, each project profile 208 associated with a user profile 204 and a project 114. Further, a second instruction set integrated with the first instruction set may generate privilege levels 210 associated with the user profiles 204 and the project profiles 208.

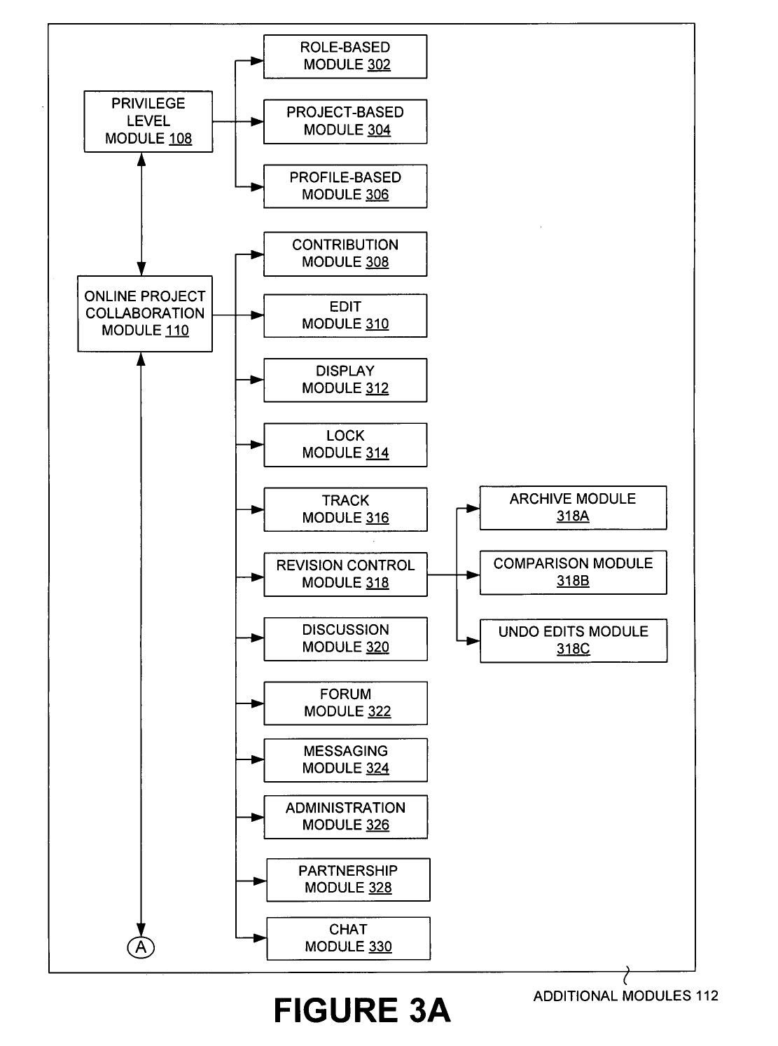

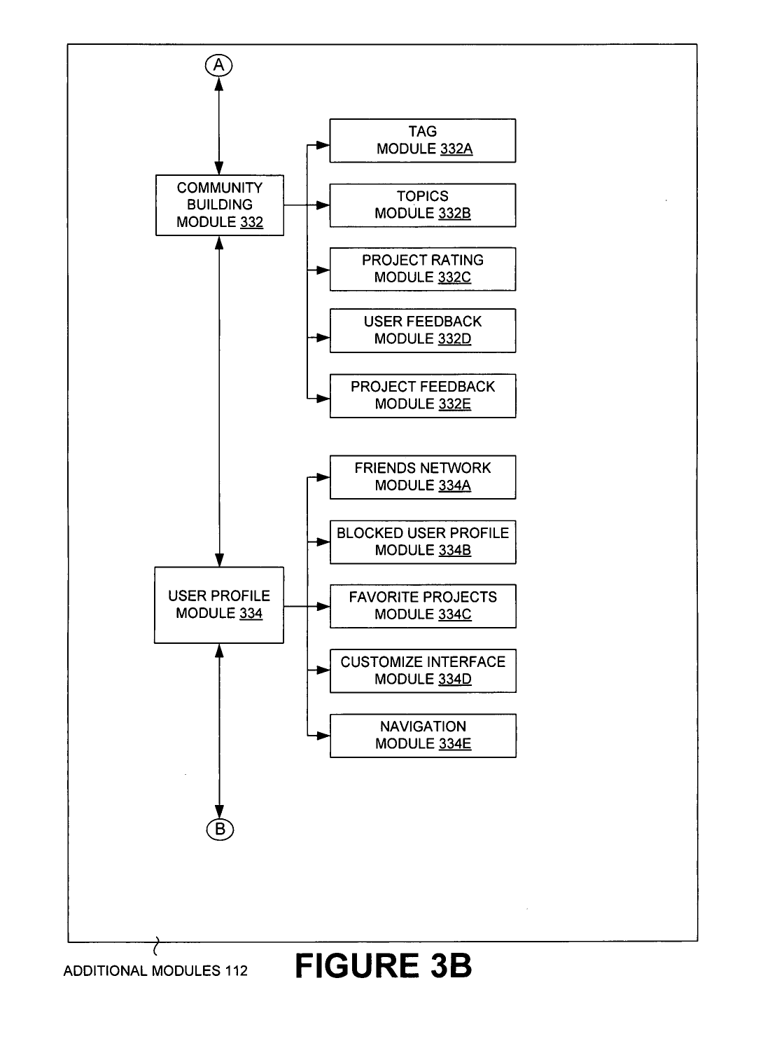

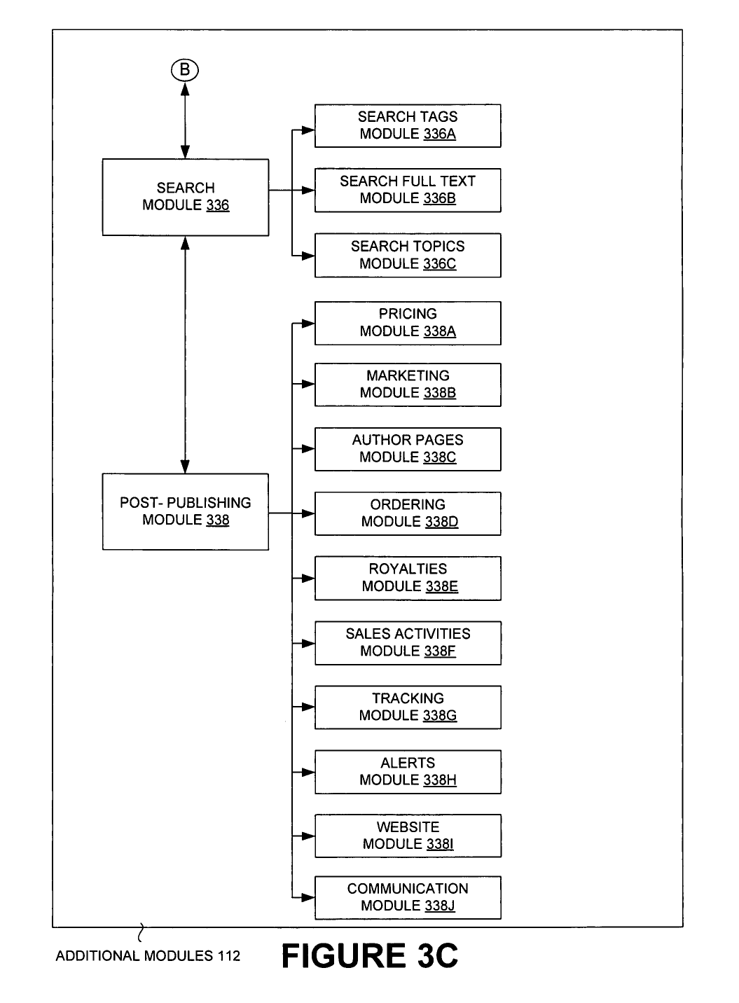

In addition, a third instruction set integrated with the first instruction set and the second instruction set may generate an online collaboration (e.g., using the online project collaboration module 110 of FIG. 1) between a user profile 204 and a project 114 of a project profile 208. A fourth instruction set integrated with the first instruction set, the second instruction set and the third instruction set may generate a display (e.g., using the display module 312 of FIG. 3A) associated with the online collaboration, the user profile 204, the project profile 208 and/or the project 114.

FIG. 2 is an exploded view of the community network module 106 of FIG. 1, according to one embodiment. Particularly, FIG. 2 illustrates the community network module 106, a community network 200, a user database 202, user profiles 204, a project database 206, project profiles 208 and privilege level(s) 210, according to one embodiment.

The community network 200 may be a network formed by association of the users 102 having the user profiles 204 in the community environment 100. For example, the users 102 may include writers, editors, contributors, readers, coeditors, etc. The user database 202 may include the user profiles 204 associated with the users 102 of the community network 200. The user profiles 204 may contain profile information associated with the users 102 of the community network 200. For example, the profile information may include a name, picture, profile history, interests, contributions, ratings, etc.

The project database 206 may include the projects 114 of the project profiles 208 associated with the user profiles 204. In one example embodiment, each project profile may be associated with one or more one user profiles 204 and a project 114. For example, the project 114 may be an uncompleted portion of a project profile 208, associated with a user profile 204, which has been completed by working together with other users 102 of the community network 200.

The project profiles 208 may be wooks (e.g., books, magazines, periodicals, etc.) having the projects 114 (e.g., uncompleted chapters, topics, subtopics, and/or other content) that are to be completed by taking considerations of other users 102 of the community network 200. The privilege levels 210 may be rights or permissions granted to the users 102 associated with user profiles 204 regarding the projects 114 associated with the project profiles 208. In one example embodiment, the users 102 may access a particular project 114 associated with a project profile 208 based on the privilege level(s) 210 assigned to the users 102.

In the example embodiment illustrated in FIG. 2, the community network module 106 may generate the community network 200 which includes the user database 202, the user profiles 204, the project database 206, the project profiles 208 and the privilege levels 210. The user database 202 containing the user profiles 204 communicates with the project database 206 containing the project profiles 208. The privilege level(s) 210 communicates with the user profiles 204 and the project profiles 208.

In one embodiment, the user profiles 204 may be generated (e.g., using the user database 202 of FIG. 2). The project profiles 208 may be generated (e.g., using the project database 206 of FIG. 2), each project profile 208 associated with a user profile 204.

FIG. 3 is an exploded view of the additional modules 112 of FIG. 1, according to one embodiment. Particularly, FIG. 3A illustrates the privilege level module 108, the online project collaboration module 110, a role-based module 302, a project-based module 304, a profile-based module 306, a contribution module 308, an edit module 310, a display module 312, a lock module 314, a track module 316, a revision control module 318, an archive module 318A, a comparison module 318B, an undo edits module 318C, a discussion module 320, a forum module 322, a messaging module 324, an administration module 326, a partnership module 328 and a chat module 330, according to one embodiment.

The role-based module 302 may designate role-based privilege levels associated with the projects 114 to the users 102. For example, each user 102 may be assigned one or more role-based privilege levels (e.g., a reader level, a contributor level, an editor level, and/or a coeditor level, etc.) to access the project profiles 208 which are not accessed by all.

The project-based module 304 may designate a project-based privilege level such as a public level, a private level, and/or a prohibited content level associated with the project profiles 208. For example, publicly available projects 114 may be viewed by all the users 102 of the community environment 100 where as private projects 114 may be viewed by the members (e.g., registered users) of the community network 200. In addition, prohibited content level may restrict access to certain portion of the project 114.

The profile-based module 306 may designate a profile-based privilege level such as a prohibited user profile level to the users 102 of the community environment 100. For example, the user 102 (e.g., writer, editor, author, etc.) of the project 114 may restrict access associated with the project 114 to other user profiles (e.g., the other user profiles 204B of FIG. 4) if the interests associated with the other user profiles 204B does not match with the requirements of the project 114.

The contribution module 308 may enable contribution of material from the other user profiles 204B of the community network 200 based on an online project collaboration between the project profile 208 and the other user profiles 204B. The contributors can write, edit, research some stuff about the project 114, generate feedbacks and/or post comments regarding the project 114.

The edit module 310 may enable the user 102 to edit content (e.g., the content 404 of FIG. 4) associated the project 114 associated with the project profile 208. For example, the edits (e.g., the edits 406 of FIG. 4) may be highlighted in different colors (e.g., may appear in yellow, green, red, etc.) in order to identify the changes made to an original version.

The display module 312 may display a portion of the project 114 associated with the project profile 208. For example, the display module may generate a display view (e.g., the display view 400 of FIG. 4) that includes the privilege level(s) 210 associated with the project 114 and the user profiles 204. Further, the portion of the project 114 may be displayed to other users 102 according to a predetermined structure based on search associated with the project 114.

The lock module 314 may lock a portion of the project 114 associated with the project profile 208. For example, the user 102 (e.g., editor, author, etc.) may lock certain amount of data associated with the project 114 prior to assigning the privilege level(s) 210 to the other user profiles 204B. As a result, the user 102 may retrieve original project 114 if the edits 406 made by the other user profiles 204B are not pertinent.

The track module 316 may track (e.g., identify, process, manage and/or store) information associated with the contributed material of the project 114 and provide control over edits (e.g., the edits 406 of FIG. 4) made by the other users 102 (e.g., contributors, coeditors, etc.) to the user 102 (e.g., writer, editor, author, etc.). For example, the user 102 (e.g., writer, editor, author, etc.) may keep updates of the edits 406 made by other contributors to the content 404 of the project 114 in order to identify differences between the original version and the modified version.

The revision control module 318 may control revisions to the project 114. For example, multiple revisions and/or changes made to documents of the same project 114 by different users 102 (e.g., writer, editor, author, co-editor, contributor, etc.) may be managed using the revision control module 318. In one example embodiment, the archive module 318A may archive one or more versions of the project 114. For example, the current version and one or more modified versions of the project 114 may be stored on the project website.

The comparison module 318B may display the one or more versions of the project 114 and identify differences between the current version and the previous version of the project 114. For example, the user 102 (e.g., writer, editor, author, etc.) may distinguish between his/her version and the modified version of the contributors in order to finalize or freeze the project 114 by accepting or rejecting changes. The undo edits module 318C may generate a previous version of the project 114 by reversing the edits 406 to the current version of the project 114. For example, the user 102 may retrieve original version if the edits 406 made by the other user profiles 204B to the original version are not relevant.

The discussion module 320 may enable a discussion associated with a user profile 204 and a project profile 208. For example, the discussion may be a website where the user 102 associated with user profile 204 may post informal journals of their thoughts, comments, and/or philosophies, which are updated frequently. For example, the user 102 (e.g., contributors, readers, etc.) may share his/her thoughts associated with the project 114 by posting content associated with the project 114 in an interactive format on the project webpage.

The forum module 322 may generate a forum to display comments associated with the user profiles 204 and the project profiles 208. For example, the forum may be a web application for carrying out discussion and/or posting user generated content related to the project 114 by the users 102 of the community network 200.

The messaging module 324 may process correspondences between the user profiles 204. For example, during the online project collaboration, the users 102 (e.g., contributor, editor, coeditor, reader, writer, author, etc.) may send open messages regarding the project 114 and also share their thoughts by suggesting improvements in the project 114.

The administration module 326 may manage the online project collaboration which includes managing forums (e.g., adding forums, removing forums), system tags (e.g., through making, accepting additions to tag lists, etc.), project genres (e.g., through modifying genre list, moving projects between genres, etc.) The managing of the online collaboration may include editing (e.g., deleting, modifying, etc.) inappropriate content, and/or content marked as liability risk and/or blocking users and/or content associated with the liability risk. The administration module 326 may enable creation of new users, adding information to a user's profile, resetting of login name and password, assigning rights to the users (e.g., associated with projects), etc. In addition, the administration module 326 may manage financial activities associated with the online project collaboration such as purchasing projects, royalties, etc. The administration module 326 may also track workflow associated with a project during the online project collaboration.

The partnership module 328 may build bidirectional links (e.g., to transfer data) between the users associated with the online project collaboration and/or link partner content (e.g., favorite content). The partnership module 328 may enable organizations to build sub-communities (or sub-domains) within applications to provide targeted solutions for corporate users through a repurposed model and/or place an application appearance around a partner application's functionality through a co-branding model. The partnership module 328 may also enable branded and/or co-branded reading, writing, retailing and/or distribution of the projects. In addition, the partnership module 328 may track (e.g., to credit/debit partners) the links through reporting partner activities. The partnership module 328 may further aggregate identities through contacts, social networks, etc. The chat module 330 may generate a chat room which enables instant online communication between the users 102 regarding the project 114.

Particularly, FIG. 3B illustrates a community building module 332, a tag module 332A, a topics module 332B, a project rating module 332C, a user feedback module 332D, a project feedback module 332E, a user profile module 334, a friends network module 334A, a blocked user profile module 334B, a favorite projects module 334C, a customize interface module 334D and a navigation module 334E, according to one embodiment.

The community building module 332 may generate community building activities. For example, the community building activities may include generating topics, generating tags, rating users, rating project and generating feedback associated with the user profile 204 and/or project profile 208.

The tag module 332A may generate tags associated with interest categories. For example, a tag may be a keyword or a term contains information (e.g., picture, article, video clip, book, etc.) about the project 114 and is used in indexing. In one example embodiment, each project 114 may be associated with different tags that are classified based on interest categories.

The topics module 332B may generate topics associated with the project profile 208. For example, a topic may be a title associated with each project 114 of the project profile 208 indicating genre of the project 114.

The project rating module 332C may rate the project 114 associated with the project profile 208. For example, the users 102 (e.g., contributors, readers, other users, etc.) may rate the project 114 based on the quality and/or other features associated with the project 114. The user feedback module 332D may generate feedback related to the user 102 associated with the user profile 204 regarding the edits 406 in the project 114.

For example, the edit 406 made by the contributors to the project 114 may either be accepted or declined by user 102 (e.g., writer, editor, author, etc.) depending on the validity of the edits 406 associated with the project 114. The project feedback module 332E may generate feedback related to the project 114 associated with the project profile 208. For example, the contributors may share their ideas regarding the project 114 by giving feedback to the user 102 associated with the project 114. The feedback for the project 114 may be useful to improve the quality of the project 114.

The user profile module 334 may personalize the user profiles 204. For example, the personalizing the user profiles 204 may include managing and/or controlling the information associated with the user profile 204. The friends network module 334A may associate a user profile (e.g., of the user profiles 204 of FIG. 2) with the user profile 204 and enable communication between the two user profiles 204. For example, the user 102 (e.g., writer, editor, author, etc.) may personalize his/her user profile 204 by associating with other user profiles 204 to create a friends network.

The blocked user profile module 334B may block one or more user profiles 204. For example, the user 102 (e.g., writer, editor, author, etc.) may invite certain users to contribute for the project 114 and block the other users based on the interest level associated with each user profile 204.

The favorite projects module 334C may generate a list of favorite projects. In one example embodiment, each favorite project may be associated with a project profile 208. For example, the user 102 (e.g., contributor, editor, writer, author, etc.) may list his favorite projects depending on an interest level and the level of contributions made by him to the projects 114.

The customize interface module 334D may manage colors and/or font styles associated with the user profiles 204 and/or project profiles 208 of the community environment 100. For example, the user 102 (e.g., writer, editor, author) may customize his webpage (e.g., displayed to others users) according to his/her wish and/or requirements. The navigation module 334E may control a location of a navigation item associated with the user profile 204 and/or the project profile 208. For example, the user 102 (e.g., writer, editor, author) may apply thoughts, plans, direct, record, and/or control the project 114 according to a predetermined structure.

In accordance with one example embodiment, community building activities may be generated (e.g., using the community building module 332 of FIG. 3B). Tags associated with interest categories may be generated (e.g., using the tag module 332A of FIG. 3B). Topics associated with the project profiles 208 may be generated (e.g., using the topics module 332B of FIG. 3B).

The project 114 associated with the project profile 208 may be rated (e.g., using the project rating module 332C of FIG. 3B). Further, the feedback related to the user 102 associated with the user profile 204 may be generated (e.g., using the user feedback module 332D of FIG. 3B).

Also, the feedback related to the project 114 associated with the project profile 208 may be generated (e.g., using the project feedback module 332E of FIG. 3B). The first user profile 204A may be personalized (e.g., using the user profile module 334 of FIG. 3B). A user profile 204 may be associated with the first user profile 204A to create a friends network (e.g., using the friends network module 334A of FIG. 3B).

The user profile 204 of the user profiles 204 may be blocked (e.g., using the blocked user profile module 334B of FIG. 3B). Further, the list of favorite projects associated with the user profile 204 may be generated (e.g., using the favorite projects module 334C of FIG. 3B), each favorite project associated with a corresponding project profile.

In addition, colors and font styles of the community environment 100 may be managed (e.g., using the customize interface module 334D of FIG. 3B). The location of a navigational item associated with the first user profile 204A and/or the first project profile 208A may be controlled (e.g., using the navigation module 334E of FIG. 3B).

Particularly, FIG. 3C illustrates a search module 336, a search tags module 336A, a search full text module 336B, a search topics module 336C, a post-publishing module 338, a pricing module 338A, a marketing module 338B, an author pages module 338C, an ordering module 338D, a royalties module 338E, a sales activities module 338F, a tracking module 338G, an alerts module 338H, a website module 3381 and a communication module 338J, according to one embodiment.

The search module 336 may generate a search associated with the user profiles 204 and the project profiles 208. For example, the user 102 (e.g., registered users and unregistered users) may search for the project profiles 208 based on his/her interests. The search tags module 336A may search tags associated with interest categories. For example, the user 102 may search for tags associated with information (e.g., a picture, article, a video clip, a book, etc) about the projects 114.

The search full text module 336B may search the user profiles 204 and/or the project profiles 208 in the full text mode. For example, the search full text module 336B may match all the search words provided by the user 102 associated with the user profile 204 with the required project. The search topics module 336C may search the project profiles 208 based on a topic (e.g., title, subtitle, etc.) and a genre (e.g., type, kind, etc.).

The post-publishing module 338 may generate post-publishing activities. For example, the post-publishing activities may include pricing, marketing, orders, royalties, sales, status, alert and/or notifications associated with completed project. In one example embodiment, the completed project may refer to a project collaborated by an online network or a project uploaded by an author without need for collaboration contributions (e.g., the project 114 that just needs to be published).

The pricing module 338A may generate a price related to the completed project 114 associated with the project profile 208. For example, the price of the completed project 114 may be varied based on the interest of the users 102 in that project 114 and/or ratings associated with the completed project 114. The marketing module 338B may determine marketing preferences associated with the completed project 114.

The author pages module 338C may generate customized author pages associated with the completed project 114. For example, the user 102 (e.g., writer, editor, author, etc.) may customize his/her webpage based on his/her requirements, preferences and/or specifications. The ordering module 338D may generate orders associated with the completed project 114. For example, generating orders may include either buying and/or selling the completed project 114 which has to be processed immediately in the current market.

The royalties module 338E may manage royalties associated with the completed project 114. For example, the royalties may correspond to proprietary rights associated with the completed project 114. For example, the user 102 (e.g., writer, editor, author) may sell their copyright to publishing media (e.g., periodical, website, etc.). The sales activities module 338F may manage sales activities associated with the completed project 114. For example, sales activities may include techniques to increase profits and/or sales.

The tracking module 338G may capture (e.g., store, record, track, etc.) information associated with a status of the completed project 114. The alerts module 338H may generate alerts and/or notifications associated with the completed project 114. For example, the alerts module 338H may notify the users 102 about the new projects 114 that are published in the website.

The website module 338I may generate a website to promote the completed project 114. In one example embodiment, the website may be dedicated to a particular topic and may be updated with the latest news, views and/or trends in order to provide publicity associated with the completed project 114. The communication module 338J may generate a communication associated with the completed project 114. For example, the communication may include buying, selling, viewing, etc. the completed project 114 by the users 102 of the community environment 100.

In accordance with one example embodiment, a post-publishing activity associated with a second project profile may be generated (e.g., using the post-publishing module 338 of FIG. 3C). A price related to a second project (e.g., the completed project) associated with the second project profile may be generated (e.g., using the pricing module 338A of FIG. 3C). Marketing preferences associated with the second project may be determined (e.g., using the marketing module 338B of FIG. 3C).

Also, customized author pages associated with the second project may be generated (e.g., using the author pages module 338C of FIG. 3C). Orders associated with the second project may be generated (e.g., using the ordering module 338D of FIG. 3C). Further, royalties associated with the second project may be managed (e.g., using the royalties module 338E of FIG. 3C). Sales activities associated with the second project may be managed (e.g., using the sales activities module 338F of FIG. 3C). A status associated with the second project may be tracked (e.g., using the tracking module 338G of FIG. 3C).

In addition, an alert and/or a notification associated with the second project may be generated (e.g., using the alerts module 338H of FIG. 3C). A website may be generated (e.g., using the website module 338I of FIG. 3C) to promote the second project. A communication associated with the second project may be generated (e.g., using the communication module 338J of FIG. 3C).

In the example embodiment illustrated in FIG. 3A, 3B and 3C, the additional modules 112 includes the privilege level module 108, the online project collaboration module 110, the community building module 332, the user profile module 334, the search module 336 and the post publishing module 338 communicating with each other. In addition, the privilege level module 108 includes the role-based module 302, the project-based module 304 and the profile-based module 306. The online project collaboration module 110 includes the contribution module 308, the edit module 310, the display module 312, the lock module 314, the track module 316, the revision control module 318, the discussion module 320, the forum module 322, the messaging module 324, the administration module 326, the partnership module 328 and the chat module 330. Further, the revision control module 318 includes the archive module 318A, the comparison module 318B and the undo edits module 318C.

The community building module 332 includes the tag module 332A, the topics module 332B, the project rating module 332C, the user feedback module 332D and the project feedback module 332E. The user profile module 334 includes the friends network module 300A, the blocked user profile module 334B, the favorite projects module 334C, the customize interface module 334D and the navigation module 334E.

The search module 336 includes the search tags module 336A, the search full text module 336B and the search topics module 336C. The post publishing module 338 includes the pricing module 338A, the marketing module 338B, the author pages module 338C, the ordering module 338D, the royalties module 338E, the sales activities module 338F, the tracking module 338G, the alerts module 338H, the website module 338I and the communication module 338J.

FIG. 4 is a block diagram illustrating generation of a display view 400, according to one embodiment. Particularly, FIG. 4 illustrates the community network module 106, the privilege level module 108, the online project collaboration module 110, the user database 202, a first user profile 204A, other user profiles 204B, the project database 206, a first project profile 208A, the privilege level(s) 210, the display module 312, the display view 400, a first project 402, content 404 and edits 406, according to one embodiment.

The display view 400 may display the first project 402 associated with the first user profile 204A and the privilege level(s) 210 associated with the first project 402 assigned to the other user profiles 204B. In addition, the first project 402 may be associated with the first project profile 208A. The first project 402 may be a portion (e.g., chapter, topic and/or sub-topic) of the first project profile 208A (e.g., book, periodical, magazine, etc.) that needs contribution from the other users 102 of the community network 200.

In one example embodiment, a first user 102 (e.g., author of the first project 402) associated with the first user profile 204A may designate the privilege levels 210 (e.g., using the privilege level module 108) associated with the first project 402 to the other user profiles 204B. The privilege level(s) 210 may include a reader level, editor level and/or contributor level. For example, the reader may view the first project 402, contributor may contribute material to the first project 402 and editor may contribute material and/or finalize the first project 402.

The content 404 may include stuff (e.g., matter, body, material, etc.) associated with the first project 402. The edits 406 may represent data that is updated and/or modified by the other users 102 associated with the other user profiles 204B. For example, the edits 406 to the content 404 associated with the first project 402 may be highlighted in different color in order to differentiate from original version of the first project 402.

In the example embodiment illustrated in FIG. 4, the display view 400 includes the first user profile 204A, the other user profiles 204B, the first project profile 208A, the privilege level(s) 210, the first project 402, the content 404 and the edits 406 interacting with each other. The community network module 106 and the online project collaboration module 110 communicate with the user database 202, the project database 206 and the privilege level module 108. The display module 312 communicates with the privilege level module 108 and generates the display view 400 as illustrated in FIG. 4.

In one embodiment, a first user 102 may be associated with a first user profile 204A and a first project profile 208A. A privilege level 210 associated with a second user profile (e.g., of the other user profiles 204B of FIG. 4) may be designated (e.g., using the privilege level module 108 of FIG. 1). The privilege level(s) 210 may be role-based privilege levels (e.g., may be a reader level, a contributor level, an editor level, and/or a coeditor level), project-based privilege level (e.g., may be a public level, a private level, and/or a prohibited content level), and/or profile based privilege level (e.g., may be a prohibited user profile level).

An online project collaboration (e.g., may include interacting via a wiki) may be generated (e.g., using the online project collaboration module 110 of FIG. 1) between the first project profile 208A and the second user profile 204B based on the privilege level 210. Material may be contributed (e.g., using the contribution module 308 of FIG. 3A) to the first project 402 (e.g., may be a book, a magazine, audio books, an advertising copy, a screenplay, a periodical, music, video, and/or a music sound file) associated with the first project profile 208A.

A portion of the first project 402 (e.g., may include a section, a chapter, cited material, and/or quoted material) associated with the first project profile 208A may be edited (e.g., using the edit module 310 of FIG. 3A). The portion of the first project 402 may be displayed (e.g., using the display module 312 of FIG. 3A) according to a predetermined structure. The portion of the first project 402 associated with the first project profile 208A may be locked (e.g., using the lock module 314 of FIG. 3A).

In addition, information associated with the contributed material may be tracked (e.g., using the track module 316 of FIG. 3A). Revisions to the first project 402 may be controlled (e.g., using the revision control module 318 of FIG. 3A). One version of the first project 402 may be archived (e.g., using the archive module 318A of FIG. 3A). Further, two versions of the first project 402 may be displayed. Differences between the two versions of the first project 402 may be identified (e.g., using the comparison module 318B of FIG. 3A). As a result, a previous version of the first project 402 may be generated by reversing edits to a current version of the first project 402 (e.g., using the undo edits module 318C of FIG. 3A).

A discussion associated with a user profile and/or a project profile may be enabled (e.g., using the discussion module 320 of FIG. 3A). A forum may be generated (e.g., using the forum module 322 of FIG. 3A) to display comments associated with the user profiles 204 and the project profiles 208. Messaging associated with a portion of the user profiles 204 may be enabled (e.g., using the messaging module 324 of FIG. 3A). The online collaboration may be managed (e.g., using the administration module 326 of FIG. 3A). The partner-related activities may be managed (e.g., through the partnership module 328 of FIG. 3A). Chatting associated with the portion of the user profiles 204 may be enabled (e.g., using the chat module 330 of FIG. 3A).

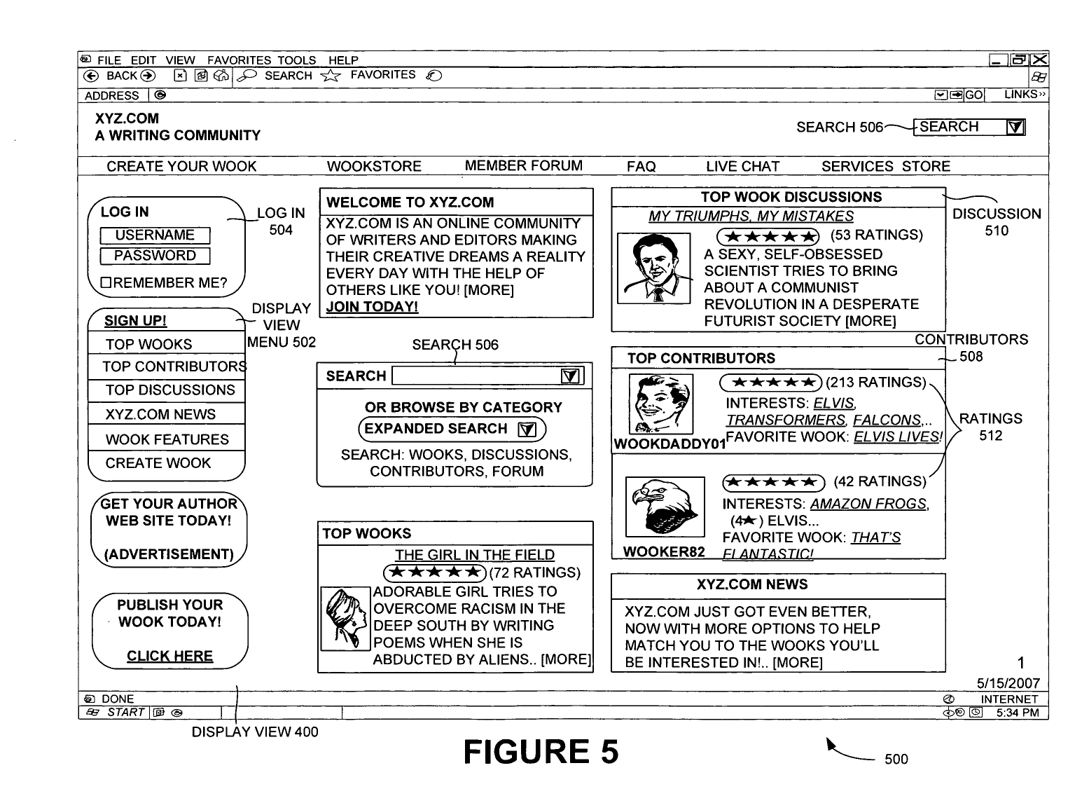

FIG. 5 is a user interface view 500 displaying a homepage associated with a website, according to one embodiment. Particularly, FIG. 5 illustrates a display view menu 502, a login option 504, a search option 506, contributors 508, a discussion 510, and ratings 512, according to one embodiment.

The display view menu 502 may provide different options through which the users 102 may view top wooks, top contributors, top discussions, news and/or other features associated with the wooks. The login option 504 may enable registered users to login into the website. In one example embodiment, the homepage associated with the users 102 may be displayed upon logging in to the website. Further, the unregistered users may register (e.g., create membership) in the website and become members of the community network 200 using sign up option (e.g., as illustrated in the display view menu 502).

The search option 506 may enable the users 102 (e.g., the registered users and the unregistered users) to browse the projects 114 associated with the project profiles 208. Further, the search option 506 may also include an expanded search option through which the users 102 may browse the projects 114 based on category such as wooks, discussions, contributors, forum, etc. In addition, the search option 506 may enable refinement of search results. For example, the search option 506 may enable users to select at least one category from available categories to filter within a search result set.

The contributors 508 may be individuals who have contributed material for a project (e.g., the first project 402 of FIG. 4) associated with a project profile (e.g., the first project profile 208A of FIG. 4). For example, contribution to the project 402 may include adding text, suggestions, and/or posting comments. The discussion 510 may be a wook (e.g., journal, magazine, periodical, audio books, an advertising copy, etc.) that is often updated (e.g., with the latest news, views and/or trends, etc.) and contains information that the writer (e.g., owner of the wook) may wish to share with other users 102 of the community environment 100.

The ratings 512 may indicate ratings associated with the user profiles 204 and/or the project profiles 208. For example, the ratings 512 associated with the user profiles 204 may be given based on a contribution level and/or interests of the users 102 whereas the ratings 512 associated with the project profiles 208 may be given based on quality, genre and/or other features of the projects 114.

In the example embodiment illustrated in FIG. 5, the user interface view 500 displays the homepage associated with the website (e.g., xyz.com). The users 102 having membership may login to the website using the login option 504. In one example embodiment, the users 102 may login to the website to browse projects (e.g., wooks), to contribute material to the interested projects and/or invite other users 102 to contribute for his/her project. The users 102 of the community environment 100 may browse the projects 114 based on category such as wooks, discussions, contributors, writers, interests, etc.

The homepage associated with the website may enable the unregistered users only to view the wooks associated with the user profiles 204 whereas the registered users may be allowed to edit content 404 associated with the wooks after logging into the website. The users 102 may edit the content 404 corresponding to the privilege level assigned to each user 102. In addition, the users 102 may view the contributors 508, ratings 512 associated with the contributors 508 and/or wooks, and/or discussions associated with the wooks corresponding to the search query.

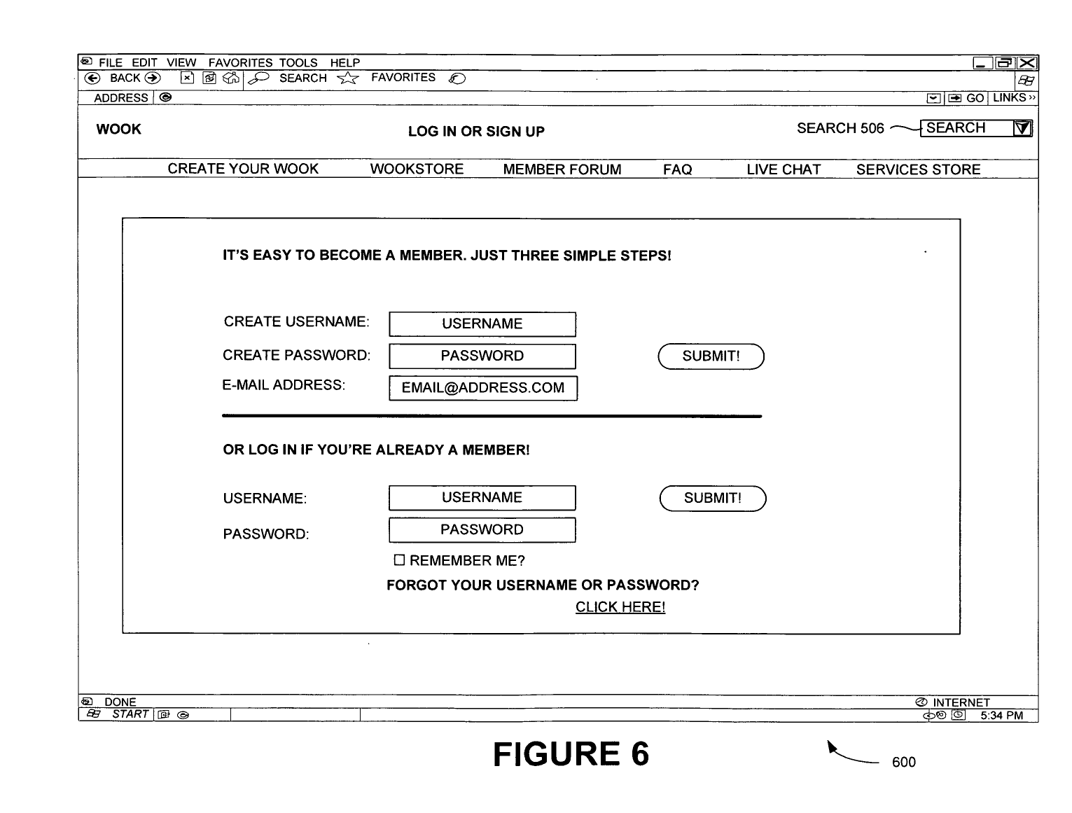

FIG. 6 is a user interface view 600 displaying a login and sign up page associated with the website, according to one embodiment. In one embodiment, unregistered users of the community environment 100 may create membership in the community network 200 by creating a new user name and password (e.g., using the create user name and create password option as illustrated). For example, the user name may be a screen name or a unique identifier associated with a user (e.g., of the users 102 of FIG. 1).

In addition, the user 102 has to specify a valid email address at the time of signing up. In one example embodiment, a confirmation of the membership of the user 102 may be sent to the specified email address upon sign up. In another embodiment, the registered users 102 (e.g., members of the community network 200) may login to the website using the corresponding user name and password.

In one example embodiment, the users 102 may login to the website to join online community of writers, editors and/or contributors who may share their thoughts to complete the project 114 and/or to publish the completed project 114 in the community network 200.

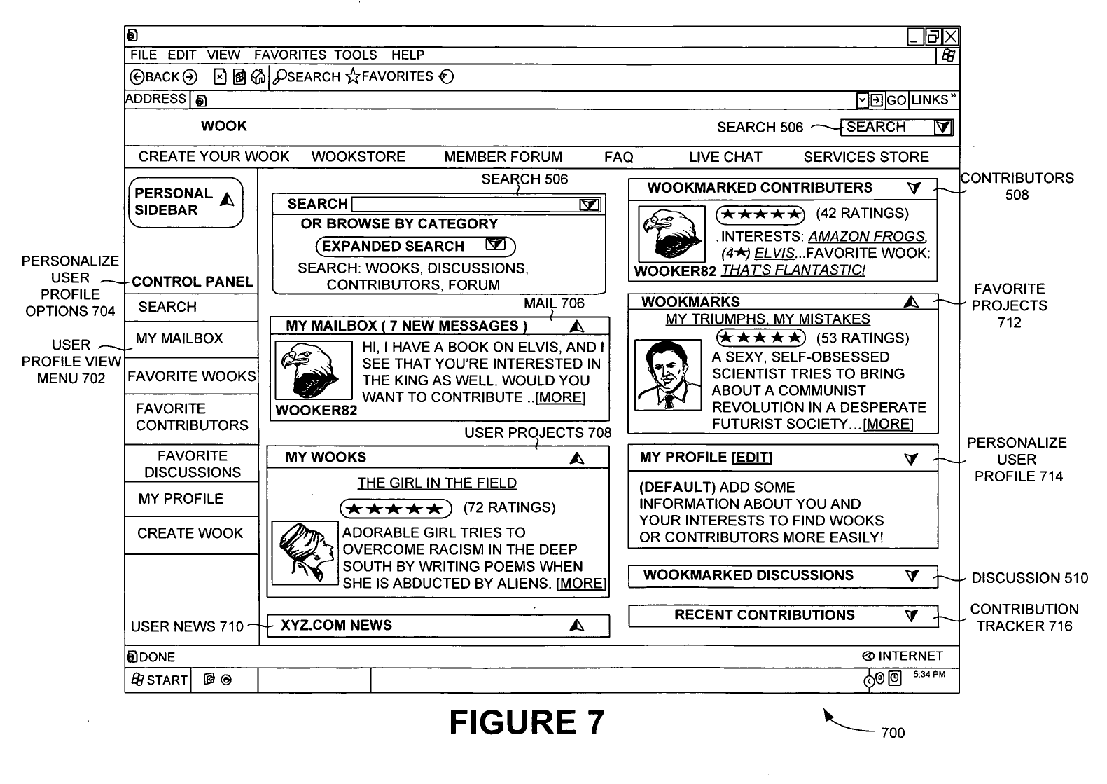

FIG. 7 is a user interface view 700 of a webpage associated with a user (e.g., of the users 102 of FIG. 1), according to one embodiment. Particularly, FIG. 7 illustrates the search option 506, the contributors 508, the discussion 510, a user profile view menu 702, personalize user profile options 704, a mail 706, user projects 708, user news option 710, favorite projects block 712, a personalize user profile option 714 and a contributions tracker 716, according to one embodiment.

The user profile view menu 702 may enable the user 102 to view information associated with his/her profile 204. For example, the information may include mails, favorite wooks, favorite contributors, favorite discussions, and profile information associated with the user 102 of the webpage. The personalize user profile options 704 may provide different options to the user 102 to personalize his/her profile 204. For example, personalizing the user profile 204 may include blocking user profiles (e.g., the user profiles 204 of FIG. 2), generating a list of favorite projects, managing colors and font styles of the community environment 100, and/or controlling a location of a navigational item associated with the user profile, etc.

The mail 706 may represent a message received from other users 102 of the community network 200 regarding the projects 114. The user projects 708 may represent projects (e.g., the projects 114 of FIG. 1) written by the user 102 and/or projects 114 to which the user 102 has contributed. The user news option 710 may provide latest information to the user 102 regarding the projects 114 that needs contribution and/or about the projects 114 that are published in the community network 200. The favorite projects block 712 may represent a list of favorite projects (e.g., of the projects 114 of FIG. 1) associated with the user 102 including ratings 512 associated with each project.

The personalize user profile option 714 may enable the user 102 to edit profile information associated with his/her profile. In one example embodiment, the user 102 may edit the profile to update personal information (e.g., interests, contributions, ratings) in order to find the projects 114 and/or the contributors 504 easily. The contributions tracker 716 may track (e.g., identify, process, manage and/or generate) recently contributed projects 114 associated with the user 102.

In the example embodiment illustrated in FIG. 7, the user interface view 700 displays the user profile 204 associated with the user 102. The user interface view 700 may enable the user 102 to browse the wooks through the search option 506. The personalize user profile options 704 may include a control panel through which the user 102 may personalize his/her profile. The user profile 204 may include wooks, contributors, wookmarks, wookmark discussions, recent contributions, etc. associated with the user 102.

The mail 706 may represent the mail received from another user ‘Wooker82’ of the community network 200. The mail displays information that Wooker82 is inviting the user 102 to contribute (e.g., share, comment, edit) to a book on Elvis. The user interface view 700 displays a wook ‘The Girl in the Field’ in the user projects 708, indicating the wook ‘The Girl in the Field’ is associated with the user 102.

The user interface view 700 also displays favorite projects of the user 102 as “My Triumphs, My Mistakes” and the ratings associated with “My Triumphs, My Mistakes” as “53” in the favorite projects block 712. Further, the user 102 may also edit his profile to update personal information (e.g., interests, contributions, etc.) which facilitates the user 102 to find wooks and/or contributors easily.

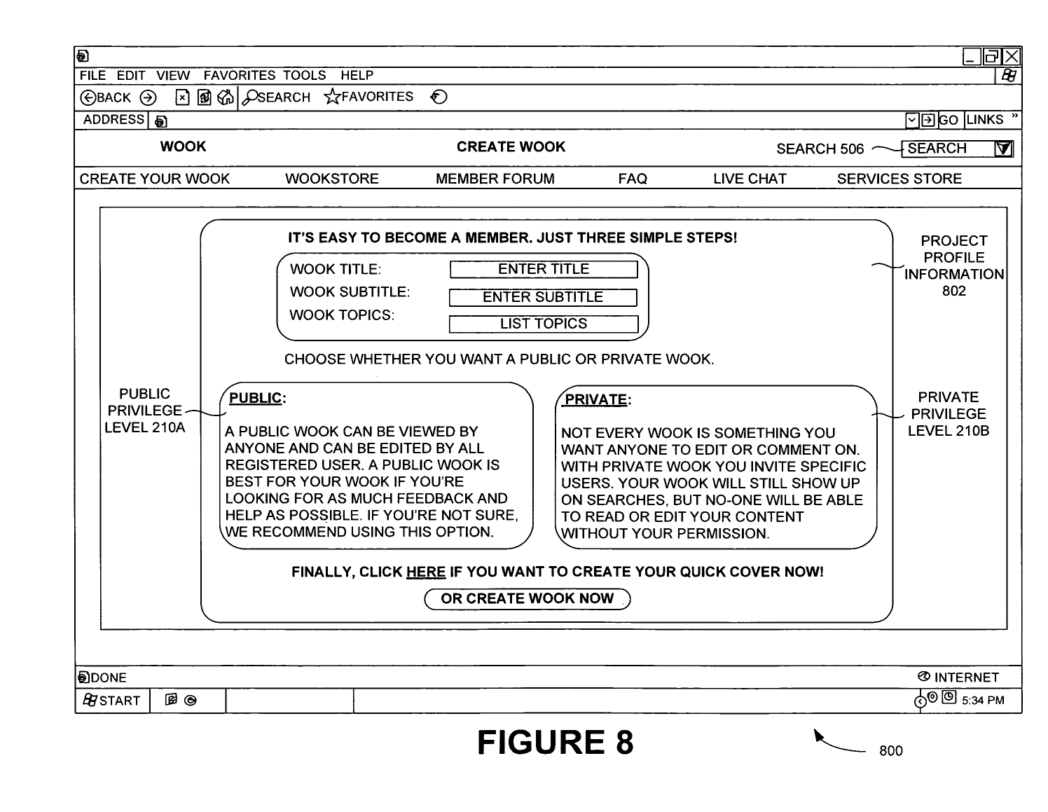

FIG. 8 is a user interface view 800 of creating the project profile 208, according to one embodiment. Particularly, FIG. 8 illustrates a public privilege level 210A, a private privilege level 210B and project profile information 802, according to one embodiment. The project profile information 802 may enable the user 102 (e.g., writer, editor, author, etc.) to update information (e.g., project title, project subtitle, list topics, etc.) associated with the project 114 while creating the project profile 208.

In the example embodiment illustrated in FIG. 8, the user interface view 800 displays a webpage of creating the project profile 208 by making use of the project profile information 802 provided by the user 102. In addition, the user 102 may assign a project-based privilege level (e.g., private, public, etc.) associated with the project profile 208. The public privilege level 210A may allow the users 102 (e.g., registered users and/or unregistered users) of the community environment 100 to view the project 114 and may be edited by all registered users of the community network 200.

The private privilege level 210B may enable only specific users (e.g., contributors) who are invited by the user 102 (e.g., writer, editor, author, etc.) to edit content 404 associated with the project 114, but the project 114 will still show based on search conducted by the other users 102, but no one will be able to read or edit the content 404. Furthermore, the user 102 may be permitted to create a quick cover related to the project 114 upon creating the project profile 208.

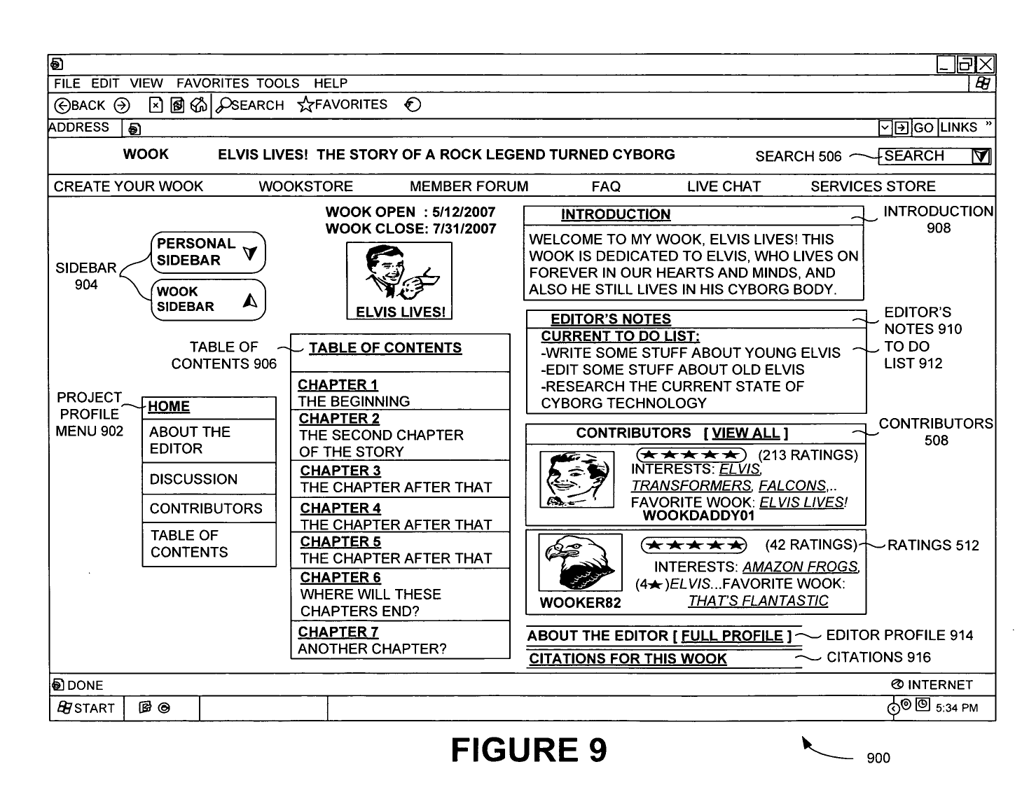

FIG. 9 is a user interface view 900 displaying a project profile (e.g., of the project profiles 208 of FIG. 2), according to one embodiment. Particularly, FIG. 9 illustrates the search option 506, the contributors 508, the ratings 512, a project profile menu 902, a sidebar 904, table of contents 906, an introduction block 908, editor's notes 910, to do list block 912, an editor profile option 914 and citations 916, according to one embodiment.

The project profile menu 902 may enable the user 102 to view details associated with the project profile 208. For example, the details may include information about editor, discussion, contributors, table of contents associated with the project profile 208. The sidebar 904 may be a block of text placed to the side of main text body in the project profile 208. The sidebar may include a personal sidebar and/or a wook sidebar. The personal sidebar may provide extra information about the user 102. The wook sidebar may provide extra information about the project profile's (e.g., wook) subject matter that is given prominence by means of a separate panel.

The table of contents 906 may display a list of chapters and topic associated with each chapter of the project profile 208. In one example embodiment, the user 102 may edit content (e.g., the content 404 of FIG. 4) associated with each chapter based on an editor's instructions (e.g., as illustrated in editor's notes 910). For example, if the editor has assigned a privilege level(s) 210 to edit content associated with chapter 2, then the user 102 may be able to edit only the content associated with chapter 2. In addition, a working outline may be included. In one embodiment, the working outline may include a tree view of the content section (or chapters) within a project that the editor or other user may use to increase and/or decrease indent level or ordinal value. The users with contributor rights may use the working outline to navigate between content sections within the book, view discussions dedicated to the content sections, and/or view summary level descriptions of the content sections when the content section is selected from within the outline.

The introduction block 908 may display a brief introduction about the project profile 208 (e.g., wook). For example, the introduction may give basic information such as genre of the wook, purpose of the wook, etc. The editor's notes 910 may display information posted by the editor of the project profile 208 (e.g., the wook) regarding incomplete work associated with the project (e.g., chapter, topic, etc.) of the project profile 208. Further, the user 102 may be assigned the privilege levels 210 associated with the project 114 based on his interest in that particular project.

The to do list block 912 may display content posted by the editor (e.g., author) of the project profile 208 regarding work to be done by the user 102 to the project 114 associated with the project profile 208. The editor profile option 914 may display profile information associated with the editor of the project profile 208. The citations 916 may be information needed to identify and/or to locate a project 114 quickly and efficiently in the community network 200. For example, a book citation may include author, title, publisher and/or year of publication while a journal citation includes author, article title and periodical title, date, volume and page numbers.

In the example embodiment illustrated in FIG. 9, the user interface view 900 displays the project profile 208. The project profile 208 may correspond to a wook (e.g., Elvis Lives). For example, the wook ‘Elvis Lives’ may be displayed to the user 102 upon accepting the invitation sent by the editor (e.g., as illustrated in the mail 706 of FIG. 7), requesting to contribute for the book on Elvis. Further, the profile information (e.g., author, contributor, contents, discussions, etc.) associated with Elvis Lives may be accessed by the user 102 using the project profile menu 902.

The table of contents 906 displays the chapter number and name of the topic associated with each chapter of the Elvis Lives. In addition, the editor's notes may indicate a portion of the Elvis Lives to be edited by the user 102 in the to do list block 912. The to do list block 912 displays “write some stuff about young Elvis, Edit Some stuff about old Elvis and research the current state of cyborg technology” indicating an amount of contribution required associated with Elvis Lives.

The contributors 508 may be contributors associated with Elvis Lives. For example, the contributors 508 may display the contributors “WookDaddy01” and “Wooker82” having 213 and 42 ratings respectively. The user 102 may also view information associated with the editor of Elvis Lives using the editor profile option 914.

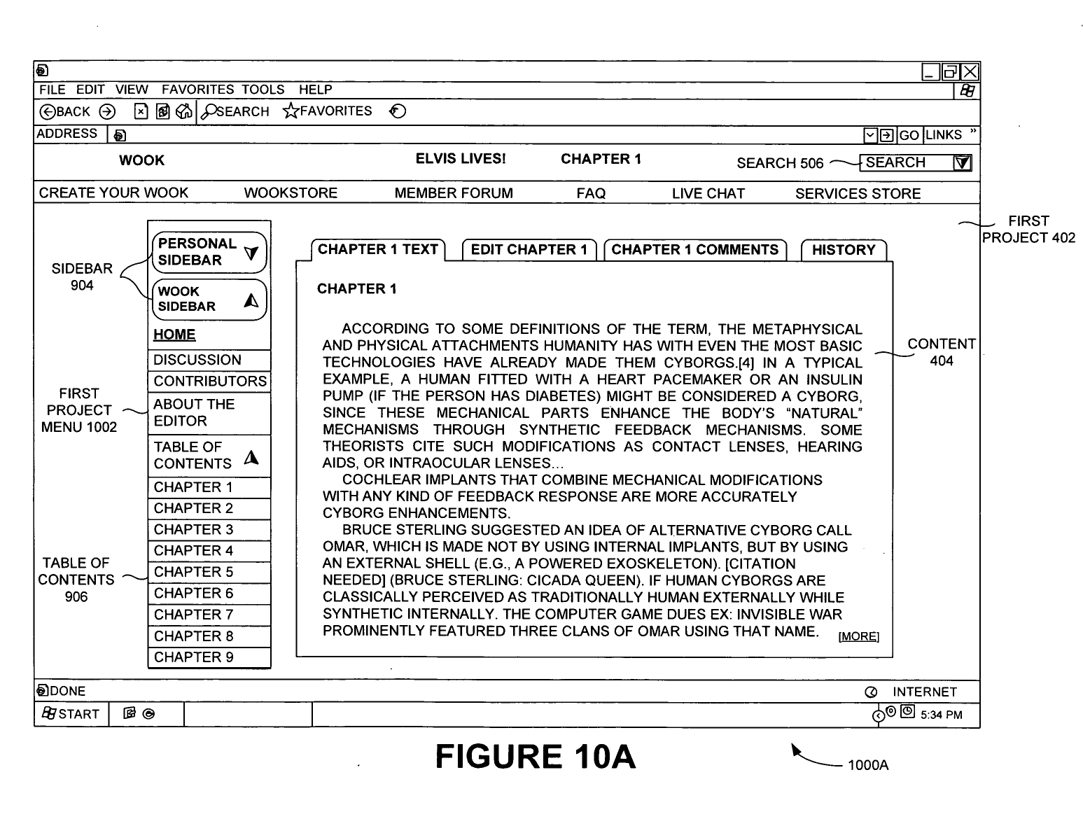

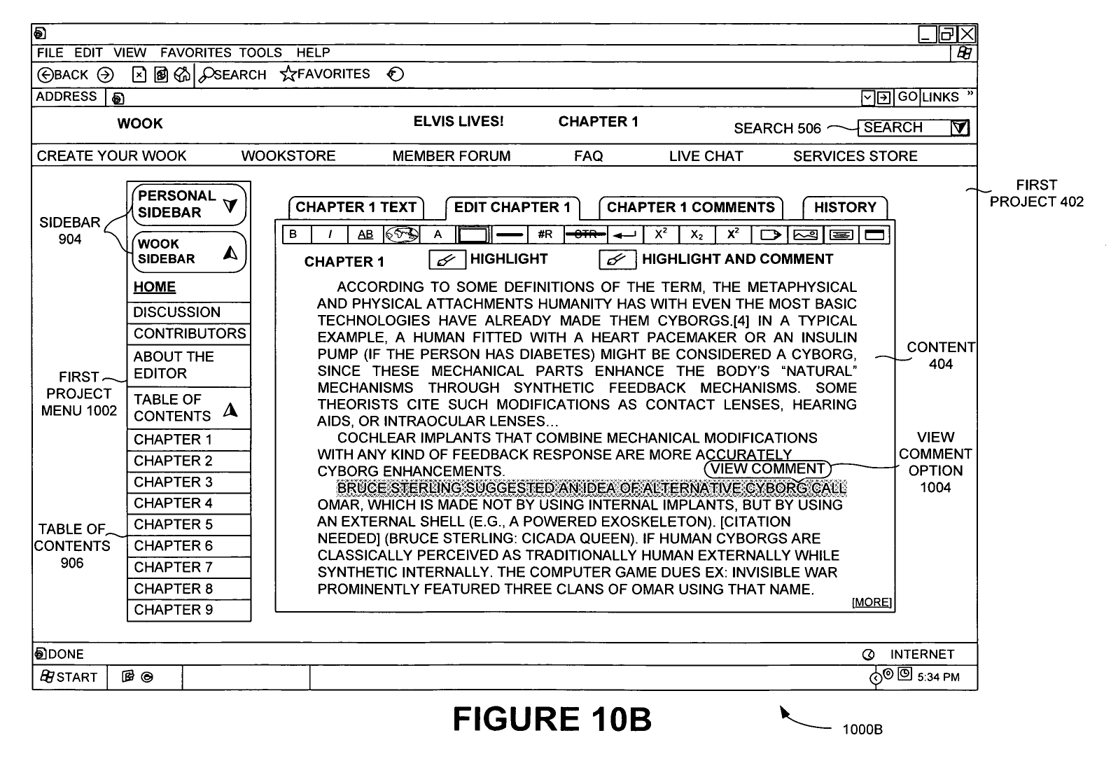

FIG. 10A is a user interface view 1000A of showing the content 404 associated with the first project 402 of the project profile 208, according to one embodiment. Particularly, FIG. 10A illustrates the first project 402, the content 404, the search option 506, the sidebar 904, the table of contents 906 and a first project menu 1002, according to one embodiment.

The first project menu 1002 may enable the user 102 to view details associated with the first project 402. For example, the details may include information about editor, discussion, contributors, table of contents associated with the first project. Further, the user 102 may select anyone of the chapters from the table of contents 906 using the first project menu 1002.

In the example embodiment illustrated in FIG. 10A, the user 102 has selected chapter 1 from the number of chapters displayed in the table of contents 906. As a result, the content 404 associated with chapter 1 may be displayed to the user 102. Further, the user 102 may edit the content 404 associated with chapter 1 based on a privilege level(s) 210 designated to the user 102. In one example embodiment, the privilege level(s) 210 may be assigned based on the user's interest in that project and/or ratings 512 associated with the user 102.

FIG. 10B is a user interface view 1000B of editing the content 404 associated with the first project 402 of the project profile 208, according to one embodiment. Particularly, FIG. 10A illustrates the first project 402, the content 404, the search option 506, the sidebar 904, the table of contents 906, the first project menu 1002 and a view comment option 1004 according to one embodiment.

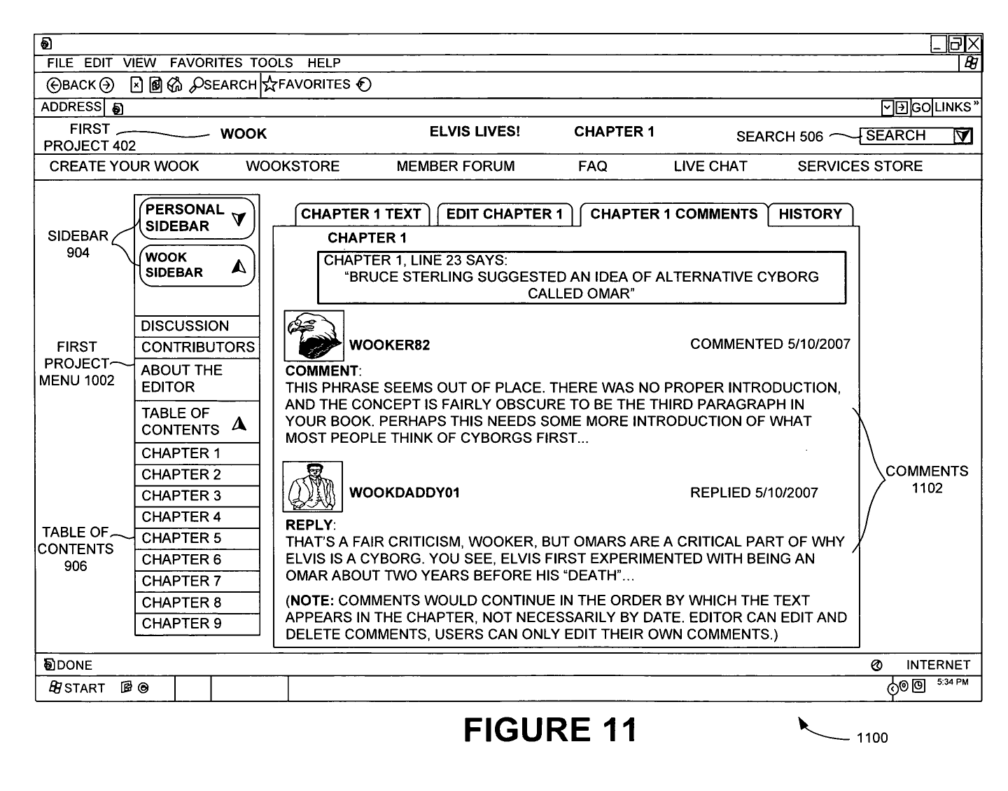

The first project menu 1002 may enable the user 102 to select different chapters associated with the project profile 208. The first project menu 1002 may also enable the user 102 to view discussion, contributors and/or details of the editor associated with the first project 402. The view comment option 1004 may enable the user 102 to view comments (e.g., the comments 1102 of FIG. 11) associated with the first project 402. The user 102 may also post comment 1102 regarding suggestions in the first project 402. Further, the editor of the first project 402 may reply to the comments posted by the user 102.

In the example embodiment illustrated in FIG. 10B, the user interface view 1000B displays the content 404 associated with chapter 1 of Elvis Lives. The user 102 may edit the content 404 associated with chapter 1 based on the privilege level(s) 210 assigned by the editor of Elvis Lives. In one example embodiment, the user 102 may be assigned as a contributor to contribute material for the first project 402. Further, the user 102 may highlight and/or comment a portion of the content 404 associated with Elvis Lives. In one example embodiment illustrated in FIG. 10B, the user 102 has posted a comment (e.g., in chapter 1, line 23), suggesting changes in that sentence.

FIG. 11 is a user interface view 1100 displaying comments 1102 associated with the first project 402, according to one embodiment. Particularly, FIG. 11 illustrates the first project 402, the search option 506, the sidebar 904, the table of contents 906, the first project menu 1002 and the comments 1102, according to one embodiment.

The comments 1102 may be posted by the other users 102 (e.g., contributors, coeditors, readers, etc.) regarding the suggestions associated with the content 404 of the first project 402. The comments 1102 may also facilitate the users 102 to share their thoughts, opinions, suggestions and/or feedback in an interactive format on the project webpage.

In the example embodiment illustrated in FIG. 11, the user interface view 1100 displays the comments 1102 posted by the users 102 (e.g., contributors) of the community network 200 regarding the first project 402. Further, the user 102 (e.g., writer, editor, author, etc.) may reply for the analysis made by the contributors 508 in the comments 1102. Furthermore, these comments 1102 can help the user 102 (e.g., writer, editor, author, etc.) to expand some stuff (e.g., material), correct mistakes, sort content, remove content, etc. associated with the first project 402.

For example, WookDaddy01 may be the user 102 (e.g., writer, editor, author, etc.) of the first project 402 (e.g., Elvis Lives) who receives comments 1102 from a contributor “Wooker82”. The Wooker82 may be interested in the project profile 208 (e.g., Elvis Lives) can post comments 1102 (e.g., regarding his concern about the Elvis Lives) to WookDaddy01 suggesting some modifications in Elvis Lives. Further, WookDaddy01 may respond to the fair analysis given by the Wooker82. In addition, WookDaddy01 may accept or reject the suggestions based on the validity of the comments 1102.

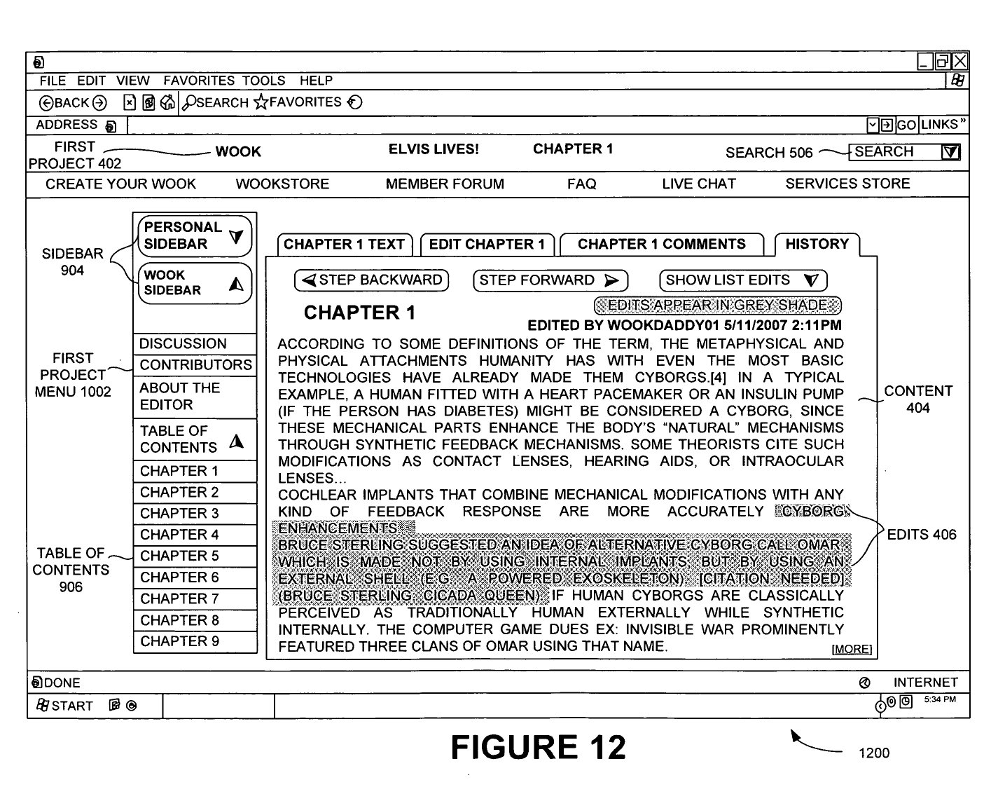

FIG. 12 is a user interface view 1200 displaying history associated with the first project 402, according to one embodiment. Particularly, FIG. 12 illustrates the first project 402, the content 404, the edits 406, the search option 506, the sidebar 904, the first project menu 1002 and the table of contents 906, according to one embodiment.

In the example embodiment illustrated in FIG. 12, the user interface view 1100 displays the content 404 associated with the first project 402 (e.g., Elvis Lives) along with the edits 406 made by WookDaddy01 dated on May 11, 2007 at 2:11 pm. In addition, Elvis Lives may include various chapters of which chapter 1 is displayed based on the requirement associated with Elvis Lives.

The edits 406 may be highlighted in a different color in order to identify the changes made to the previous version and/or for controlling revisions. In one example embodiment, the history of Elvis Lives may include information regarding the contributions (e.g., edits 406, comments 1102 and/or feedbacks) made by all the users 102 (e.g., editors, coeditors, contributors, authors, etc.) to Elvis Lives before publishing Elvis Lives.

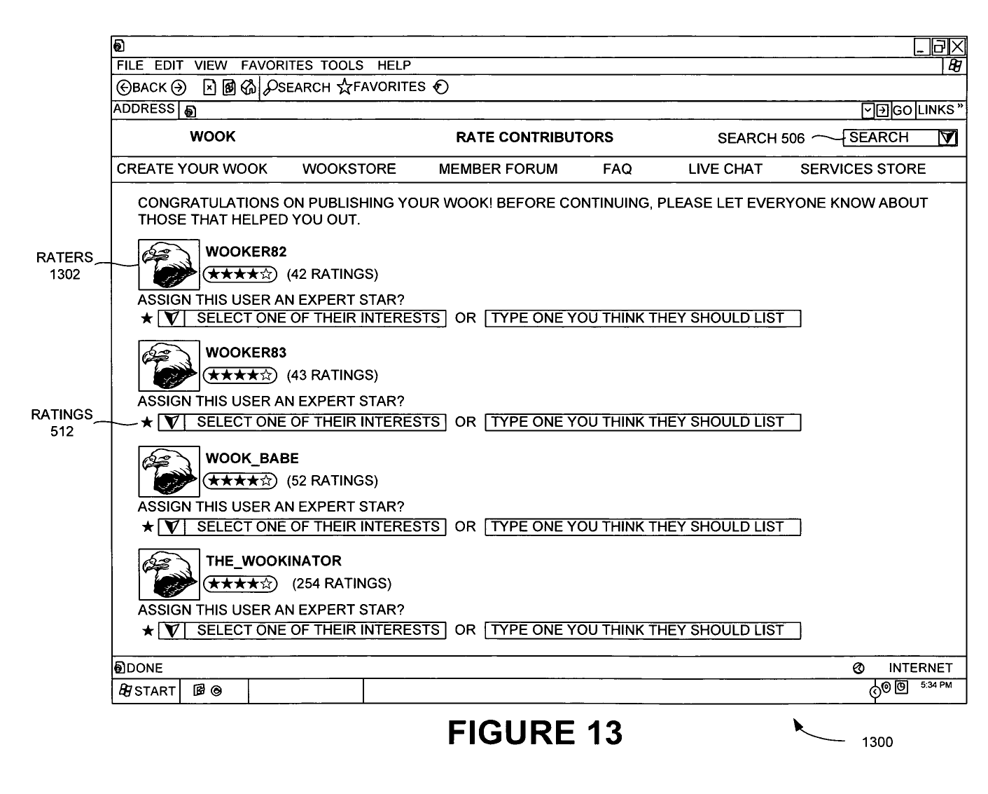

FIG. 13 is a user interface view 1300 of rating contributors 508 associated with the first project 402, according to one embodiment. Particularly, FIG. 13 illustrates the search option 506, the ratings 512 and raters 1302, according to one embodiment. The raters 1302 may be the users 102 (e.g., contributors, editors, coeditors, etc.) who have been rated according to an amount of contribution made by each user 102 to the first project 402.

In the example embodiment illustrated in FIG. 13, the user interface view 1300 displays the contributors Wooker82, Wooker83, Wook_babe, and The_Wookinator, who have been assigned stars (e.g., symbols for classification purpose) based on the amount of contribution made by them to Elvis Lives. The user interface view 1300 also displays information indicating that Elvis Lives has been published by making use of the online collaborations between the user profiles 204. The user 102 (e.g., writer, editor, author, etc.) may differentiate the contributors 508 by using star classification system and incrementing the stars based on the amount of contribution made by each user 102.

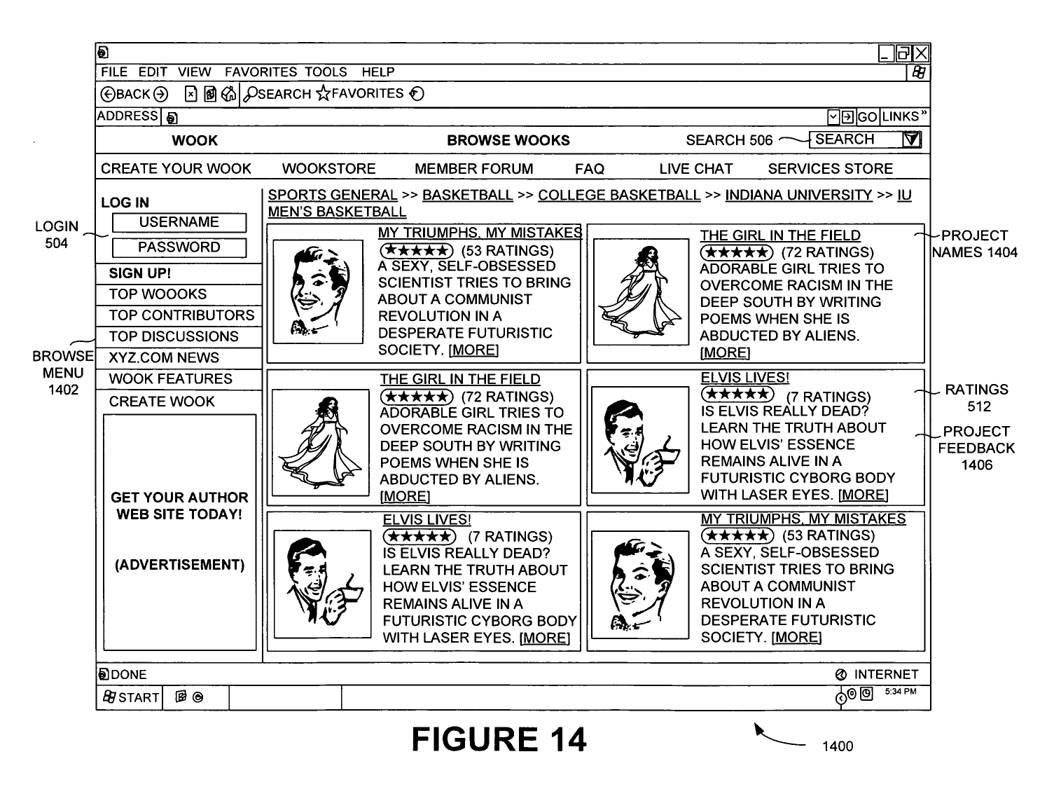

FIG. 14 is a user interface view 1400 of browsing the projects 114, according to one embodiment. Particularly, FIG. 14 illustrates the login option 504, the search option 506, the ratings 512, a browse menu 1402, project names 1404 and a project feedback 1406, according to one embodiment.

The browse menu 1402 may provide different options to browse top wooks, contributors, discussions, news and/or other features of wooks associated with the user profiles 204 in the community network 200. The project names 1404 may represent titles associated with the projects 114 which have been listed by the users 102. The project feedback 1406 may represent a feedback related to a project 114 generated by the users 102 who have been contributed for the project 114.

In the example embodiment illustrated in FIG. 14, the user interface view 1400 may enable the users 102 (e.g., registered users and unregistered users) to browse for the projects 114. The user interface view displays the projects 114 “My triumphs, my mistakes”, “The girl in the field”, “Elvis Lives”, etc. on the webpage along with the ratings 512 and the project feedback 1406. Furthermore, the unregistered users may register into the website to become the members of the community network 200 using the sign up option.

The projects 114 will be displayed on the webpage based on a search conducted by the users 102 interested in contributing the projects 114, but the content 404 may not be viewed and/or edited by the users 102 until the privilege level(s) 210 associated with the projects 114 are assigned to the users 102.

In one embodiment, a search associated with the user profiles 204 and/or the project profiles 208 may be generated (e.g., using the search module 336 of FIG. 3C). Tags associated with interest categories may be searched (e.g., using the search tags module 336A of FIG. 3C). A portion of the user profiles 204 and a portion of the project profiles 208 may be searched in full text mode (e.g., using the search full text module 336B of FIG. 3C). The project profiles 208 may be searched based on a topic and/or a genre (e.g., using the search topics module 336C of FIG. 3C).

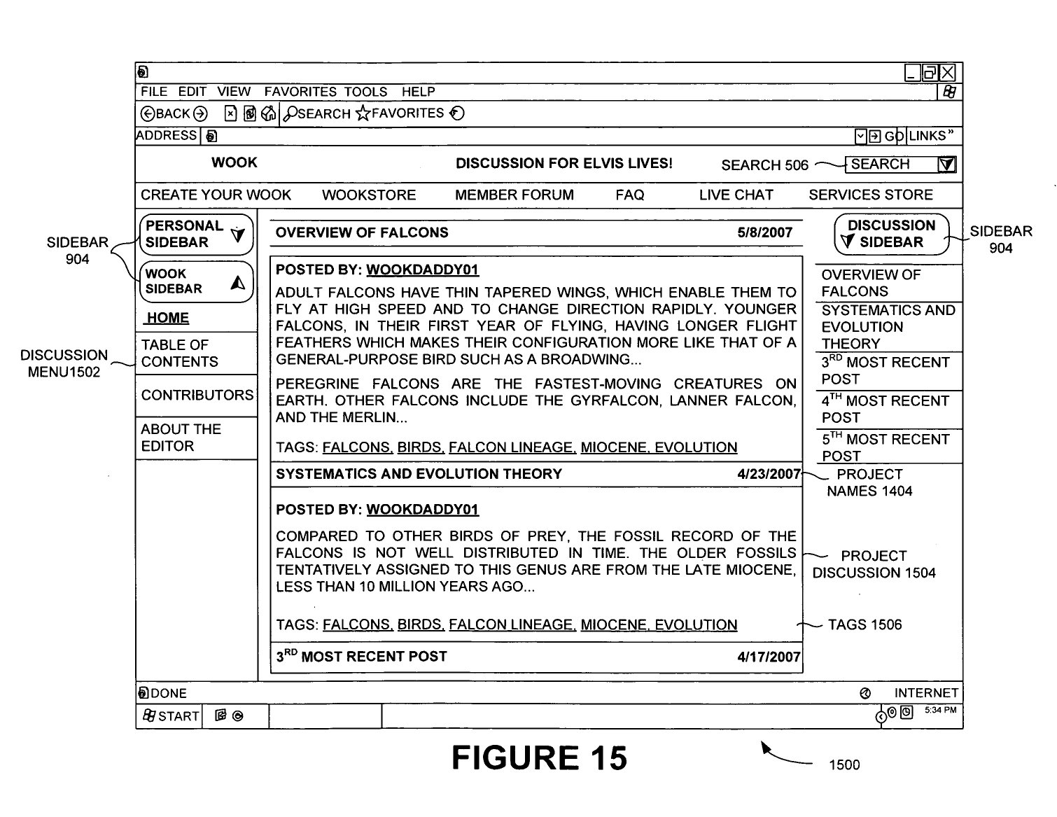

FIG. 15 is a user interface view 1500 displaying a discussion associated with the first project 402, according to one embodiment. Particularly, FIG. 15 illustrates the search option 506, the sidebar 904, a discussion menu 1502, a project discussion 1504 and tags 1506, according to one embodiment.

The discussion menu 1502 may provide different options to view discussions associated with the user profile 204 related to the first project 402. For example, the discussion may be a website where users 102 associated with user profiles 204 may post informal journals of their thoughts, comments, and/or philosophies, updated frequently and normally reflecting the views of the discussion's creator. The project discussion 1504 may display information posted by the writer regarding the first project 402. The tags 1506 may be used to store information about the project profile 208 and are used in indexing. In one example embodiment, the first project may be associated with different tags.

In the example embodiment illustrated in FIG. 15, the user interface view 1500 displays a discussion showing information posted by the editor “WookDaddy01” regarding Elvis Lives. The discussion may correspond to a wook kept on the online network (e.g., Internet). The wook may be often updated daily and contains information that the writer maintaining the discussion wishes to share with the other users 102 of the community environment 100.

The discussion may also refer to a website dedicated to a particular topic and capable of being updated with the latest news, views and trends. WookDaddy01 may be maintaining the discussion and continuously updating information regarding the wook “Elvis Lives”. For example, the user interface view 1500 displays project names “Overview of Falcons”, “Systematics and Evolution Theory” and “3^{rd} most recent post” associated with Elvis Lives and updated on dates “May 8, 2007”, “Apr. 23, 2007” and “Apr. 17, 2007” respectively. The user interface view 1500 also displays tags associated with each project discussion 1504.

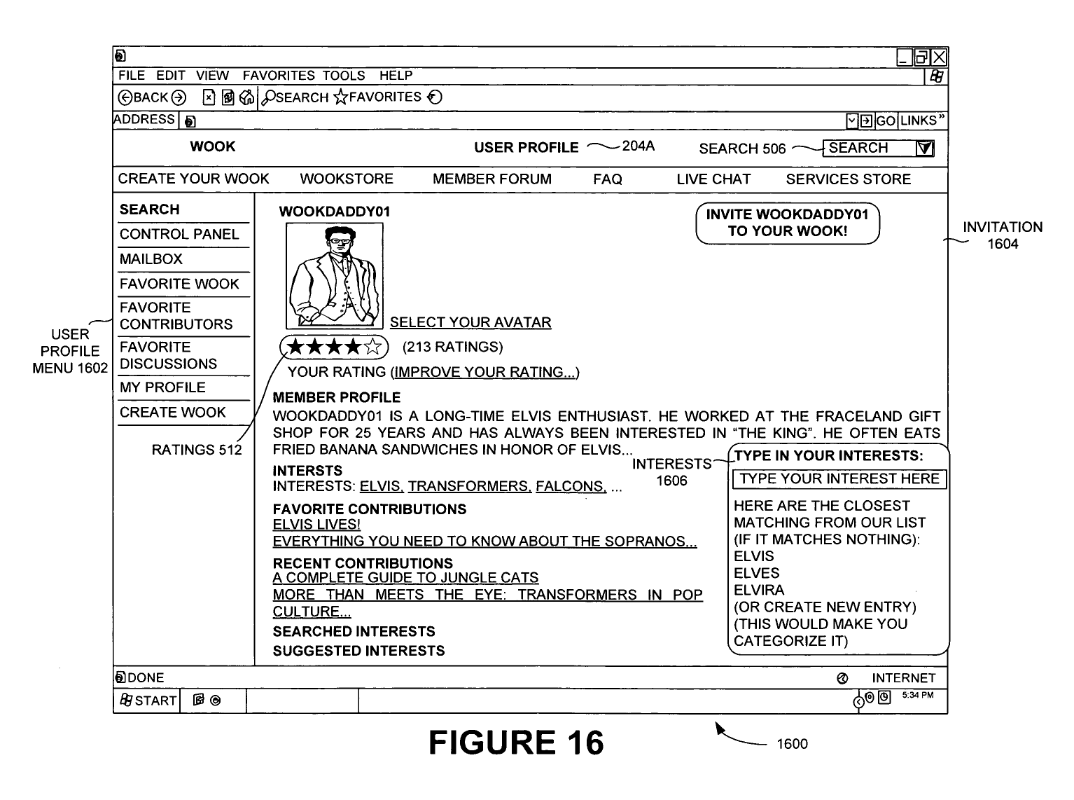

FIG. 16 is a user interface view 1600 displaying a user profile (e.g., of the user profiles 204 of FIG. 2), according to one embodiment. Particularly, FIG. 16 illustrates the search option 506, the ratings 512, a user profile menu 1602, an invitation option 1604 and interests block 1606, according to one embodiment.

The user profile menu 1602 may enable the users 102 of the community network 200 to view profile information associated with the user profile 204. For example, the profile information may include favorite wooks, favorite contributions, and/or other personal information associated with the user profile 204.

The invitation option 1604 may allow the other users 102 to invite the user associated with the user profile 204 to participate in their projects (e.g., the projects 114 of FIG. 1) associated with the project profiles 204. In one example embodiment, the users 102 of the community network 200 may invite the user associated with user profile 204 based on the interests specified in the user profile 204.

The interests block 1606 may enable the users 102 of the community network 200 to search for wooks by providing interests as a search query. Further, the interests block 1606 may display closest wooks corresponding to the interest of the users 102 based on the requested search query.

In the example embodiment illustrated in FIG. 16, the user interface view 1600 displays the user profile 204 associated with a user “WookDaddy01”. The users 102 of the community network 200 may view the profile information (e.g., wooks, contributions, discussions, profile, etc.) associated with WookDaddy01 using the user profile menu 1602. Further, the users 102 may invite WookDaddy01 to contribute for their projects based on the interests of WookDaddy01 specified in the user profile 204.

For example, if a user 102 may be looking for a contributor interested in falcons, the user 102 may invite WookDaddy01 to contribute for the wook on falcons as WookDaddy01 mentioned one of the interests as “Falcons” in the user profile 204. The user profile 204 also includes the favorite contributions and/or recent contributions made by WookDaddy01 which are displayed to other users 102 on the webpage. The users 102 may also search for the other users 102 by providing different search query as illustrated in the interests block 1606.

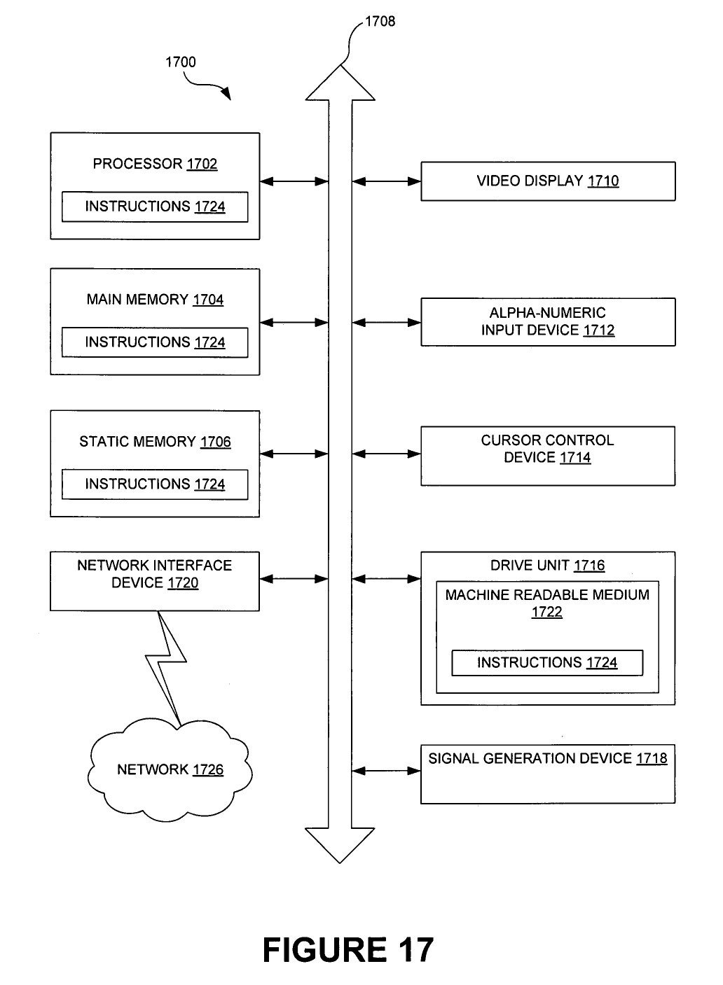

FIG. 17 is a diagrammatic system view 1700 of a data processing system in which any of the embodiments disclosed herein may be performed, according to one embodiment. Particularly, the diagrammatic system view 1700 of FIG. 17 illustrates a processor 1702, a main memory 1704, a static memory 1706, a bus 1708, a video display 1710, an alpha-numeric input device 1712, a cursor control device 1714, a drive unit 1716, a signal generation device 1718, a network interface device 1720, a machine readable medium 1722, instructions 1724 and a network 1726, according to one embodiment.

The diagrammatic system view 1700 may indicate a personal computer and/or a data processing system in which one or more operations disclosed herein are performed. The processor 1702 may be microprocessor, a state machine, an application specific integrated circuit, a field programmable gate array, etc. (e.g., Intel® Pentium® processor). The main memory 1704 may be a dynamic random access memory and/or a primary memory of a computer system.

The static memory 1706 may be a hard drive, a flash drive, and/or other memory information associated with the data processing system. The bus 1708 may be an interconnection between various circuits and/or structures of the data processing system. The video display 1710 may provide graphical representation of information on the data processing system. The alpha-numeric input device 1712 may be a keypad, keyboard and/or any other input device of text (e.g., special device to aid the physically handicapped). The cursor control device 1714 may be a pointing device such as a mouse.

The drive unit 1716 may be the hard drive, a storage system, and/or other longer term storage subsystem. The signal generation device 1718 may be a bios and/or a functional operating system of the data processing system. The network interface device 1720 may be a device that may perform interface functions such as code conversion, protocol conversion and/or buffering required for communication to and from a network. The machine readable medium 1722 may provide instructions on which any of the methods disclosed herein may be performed. The instructions 1724 may provide source code and/or data code to the processor 1702 to enable any one or more operations disclosed herein.

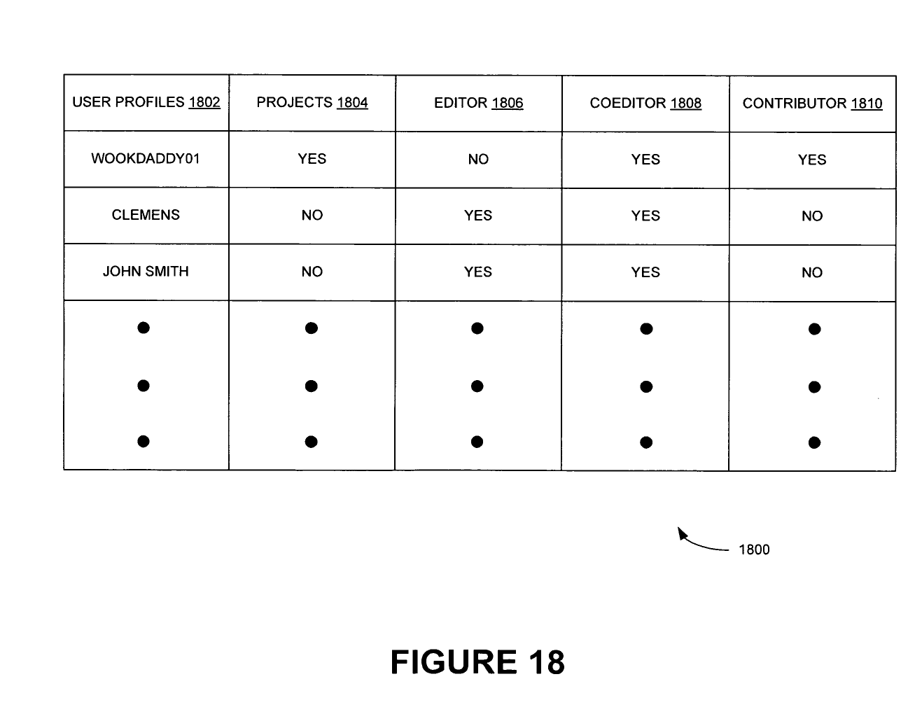

FIG. 18 is a table view 1800 displaying the privilege level(s) 210 associated with the user profiles 204 related to a project 114, according to one embodiment. Particularly, FIG. 18 illustrates a user profiles field 1802, a projects field 1804, an editor field 1806, a coeditor field 1808 and a contributor field 1810, according to one embodiment.

The user profiles field 1802 may display a unique identifier (e.g., name, code, unique key, etc.) referencing users 102 associated with the user profiles 204 in the community network 200. The projects field 1804 may indicate whether a project 114 is associated with the user profile 204 or not. The editor field 1806 may designate the editors among the user profiles 204 in the user profiles field column 1802. The coeditor field 1808 may indicate the coeditors among the user profiles 204 in the user profiles field column 1802.

The contributor field 1810 may indicate the contributors among the user profiles 204 who have been contributed material to the project 114. In one example embodiment, a user 102 may be designated the privilege level(s) 210 based on the previous contributions, ratings and/or interests associated with the user 102.

In the example embodiment illustrated in FIG. 18, the user profiles field 1802 displays “WookDaddy01” in the first row, “Clemens” in the second row and “John Smith” in the third row of the user profiles field column 1802. The projects field 1804 displays “Yes” in the first row, “No” in the second row and “No” in the third row of the projects field column 1804 indicating WookDaddy01 is the owner (e.g., author) of the project 114. The editor field 1806 displays “No” in the first row, “Yes” in the second row, and “Yes” in the third row of the editor field column 1806 indicating that Clemens and John Smith are assigned the privilege level(s) as the editor of the project 114.

The coeditor field 1808 displays “Yes” in the first row, “Yes” in the second row and “Yes” in the third row of the coeditor field column 1808 indicating that WookDaddy01, Clemens and John Smith are the coeditors of the project 114. The contributor field 1810 displays “Yes” in the first row, “No” in the second row and “No” in the third row of the contributor field column 1810 indicating that WookDaddy01 is also the contributor of the project 114.

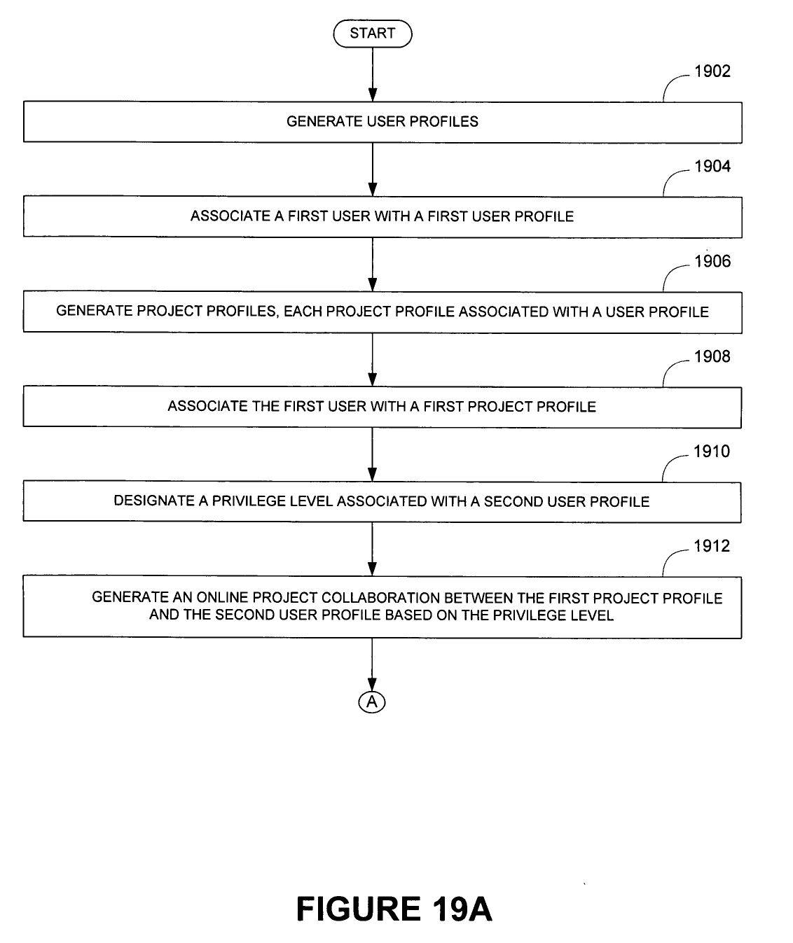

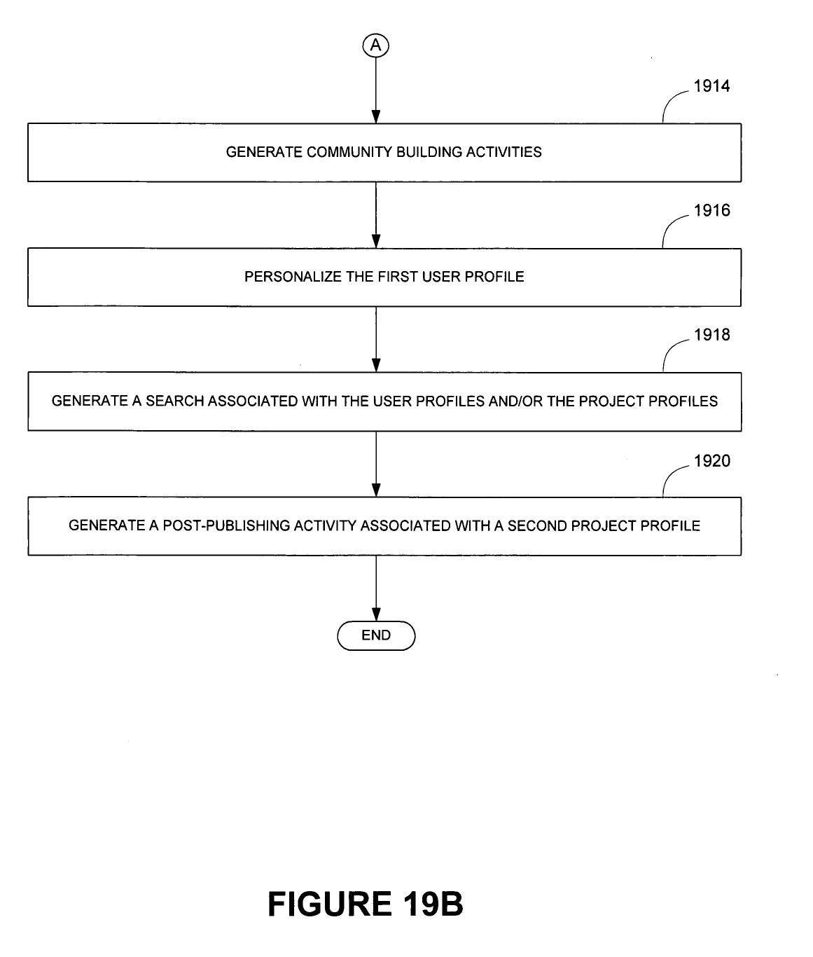

FIG. 19A is a process flow of generating an online project collaboration between project profiles (e.g., the project profiles 208 of FIG. 2) and user profiles (e.g., the user profiles 204 of FIG. 2), according to one embodiment. In operation 1902, the user profiles 204 may be generated. In operation 1904, a first user (e.g., of the users 102 of FIG. 1) may be associated with a first user profile (e.g., the first user profile 204A of FIG. 4). In operation 1906, the project profiles 208 may be generated, each project profile 208 associated with a user profile (e.g., of the user profiles 204 of FIG. 2).

In operation 1908, the first user 102 may be associated with a first project profile (e.g., the first project profile 208A of FIG. 4). In operation 1910, a privilege level (e.g., the privilege level(s) 210 of FIG. 2-4) associated with a second user profile (e.g., of the other user profiles 204B of FIG. 4) may be designated (e.g., using the privilege level module 108 of FIG. 1). In operation 1912, the online project collaboration may be generated (e.g., using the online project collaboration module 110 of FIG. 1) between the first project profile 208A and the second user profile 204B based on the privilege level(s) 210.

FIG. 19B is a continuation of the process flow of FIG. 19A, illustrating additional processes, according to one embodiment. In operation 1914, community building activities may be generated (e.g., using the community building module 332 of FIG. 3B). In operation 1916, the first user profile 204A may be personalized (e.g., using the user profile module 334 of FIG. 3B). In operation 1918, a search associated with the user profiles 204 and/or the project profiles 208 may be generated (e.g., using the search module 336 of FIG. 3C).

In operation 1920, a post-publishing activity associated with a second project profile may be generated (e.g., using the post-publishing module 338 of FIG. 3C). For example, the second project profile may be a project 114 collaborated by the users 102 of the online network (e.g., Internet) and/or a project 114 uploaded by an author without need for collaboration contributions that just needs to be published.

Although the present embodiments have been described with reference to specific example embodiments, it will be evident that various modifications and changes may be made to these embodiments without departing from the broader spirit and scope of the various embodiments. For example, the various devices, modules, analyzers, generators, etc. described herein may be enabled and operated using hardware circuitry (e.g., CMOS based logic circuitry), firmware, software and/or any combination of hardware, firmware, and/or software (e.g., embodied in a machine readable medium).

For example, the various electrical structure and methods may be embodied using transistors, logic gates, and electrical circuits (e.g., Application Specific Integrated Circuitry (ASIC) and/or in Digital Signal Processor (DSP) circuitry). For example, the community network module 106, the privilege level module 108, the online project collaboration module 110, the role-based module 302, the project-based module 304, the profile-based module 306, the contribution module 308, the edit module 310, the display module 312, the lock module 314, the track module 316, the revision control module 318, the archive module 318A, the comparison module 318B, the undo edits module 318C, the discussion module 320, the forum module 322, the messaging module 324, the administration module 326, the partnership module 328, the chat module 330, the community building module 332, the tag module 332A, the topics module 332B, the project rating module 332C, the user feedback module 332D, the project feedback module 332E, the user profile module 334, the friends network module 334A, the blocked user profile module 334B, the favorite projects module 334C, the customize interface module 334D, the navigation module 334E, the search module 336, the search tags module 336A, the search full text module 336B, the search topics module 336C, the post-publishing module 338, the pricing module 338A, the marketing module 338B, the author pages module 338C, the ordering module 338D, the royalties module 338E, the sales activities module 338F, the tracking module 338G, the alerts module 338H, the website module 338I, the communication module 338J and other modules of FIGS. 1-19B may be enabled using a community network circuit, a privilege level circuit, an online project collaboration circuit, a role-based circuit, a project-based circuit, a profile-based circuit, a contribution circuit, an edit circuit, a display circuit, a lock circuit, a track circuit, a revision control circuit, an archive circuit, a comparison circuit, an undo edits circuit, a discussion circuit, a forum circuit, a messaging circuit, an administration circuit, a partnership circuit, a chat circuit, a community building circuit, a tag circuit, a topics circuit, a user rating circuit, a project rating circuit, a user feedback circuit, a project feedback circuit, a user profile circuit, a friends network circuit, a blocked user profile circuit, a favorite projects circuit, a customize interface circuit, a navigation circuit, a search circuit, a search tags circuit, a search full text circuit, a search topics circuit, a post-publishing circuit, a pricing circuit, a marketing circuit, an author pages circuit, an ordering circuit, a royalties circuit, a sales activities circuit, a tracking circuit, a alerts circuit, a website circuit, a communication circuit and other circuits using one or more of the technologies described herein.

In addition, it will be appreciated that the various operations, processes, and methods disclosed herein may be embodied in a machine-readable medium and/or a machine accessible medium compatible with a data processing system (e.g., a computer system), and may be performed in any order. Accordingly, the specification and drawings are to be regarded in an illustrative rather than a restrictive sense.

What is claimed is:

1. A method, comprising:
generating user profiles;
associating a first user with a first user profile of the user profiles;
generating project profiles, each project profile of the project profiles associated with at least one user profile of the user profiles;
associating the first user with a first project profile of the project profiles; designating a privilege level associated with a second user profile of the user profiles; and generating an online project collaboration between the first project profile of the project profiles and the second user profile of the user profiles based on the privilege level.

2. The method of claim 1, wherein the online project collaboration comprises at least one of:
contributing material to a first project associated with the first project profile; editing at least a portion of the first project associated with the first project profile;
displaying at least a portion of the first project according to a predetermined structure;
locking at least a portion of the first project associated with the first project profile;
tracking information associated with the contributed material;
controlling revisions to the first project;
a discussion associated with at least one of a user profile of the user profiles and a project profile of the project profiles;
generating a forum to display comments associated with the user profiles and the project profiles;
messaging associated with at least a portion of the user profiles;
managing the online project collaboration;
managing partner-related activities; and
chatting associated with at least a portion of the user profiles.

3. The method of claim 2, wherein the at least a portion of the first project comprises a section, a chapter, cited material, and quoted material.

4. The method of claim 2, wherein the controlling revisions to the first project comprises:
archiving at least one version of the first project;
displaying at least two versions of the first project;
identifying differences between the at least two versions of the first project; and
generating a previous version of the first project by reversing edits to a current version of the first project.

5. The method of claim 2, wherein the first project is associated with at least one of a book, a magazine, audio books, an advertising copy, a screenplay, a periodical, music, video, and a music sound file.

6. The method of claim 1, further comprising generating community building activities.

7. The method of claim 6, wherein the generating community building activities comprises:
generating tags associated with interest categories;
generating topics associated with the project profiles;
rating a project associated with a project profile;
generating feedback related to a user associated with a user profile; and
generating feedback related to a project associated with a project profile.

8. The method of claim 1, further comprising personalizing the first user profile of the user profiles.

9. The method of claim 8, wherein the personalizing the first user profile of the user profiles comprises at least one of:
associating at least one user profile of the user profiles with the first user profile of the user profiles to create a friends network;
blocking at least one user profile of the user profiles;
generating a list of favorite projects, each favorite project associated with a corresponding project profile of the project profiles;
managing colors and font styles of the community environment; and
controlling a location of a navigational item associated with at least one of the first user profile of the user profiles and the first project profile of the project profiles.

10. The method of claim 1, further comprising generating a search associated with at least one of the user profiles and the project profiles.

11. The method of claim 10, wherein the generating a search comprises:
searching tags associated with interest categories;
searching at least a portion of the user profiles and at least a portion of the project profiles in full text mode; and
searching the project profiles based on at least one of a topic and a genre.

12. The method of claim 1, wherein the privilege level comprises at least one of role-based privilege levels, project-based privilege level, and profile-based privilege level.

13. The method of claim 12, wherein the role-based privilege levels comprises at least one of a reader level, a contributor level, an editor level, and a coeditor level.

14. The method of claim 12, wherein the project-based privilege level comprises at least one of a public level, a private level, and a prohibited content level.

15. The method of claim 12, wherein the profile-based privilege level comprises a prohibited user profile level.

16. The method of claim 1, further comprising generating a post-publishing activity associated with a second project profile of the project profiles.

17. The method of claim 16, wherein the generating post-publishing activity comprises at least one of:
generating a price related to a second project associated with the second project profile of the project profiles;
determining marketing preferences associated with the second project;
generating customized author pages associated with the second project;
generating orders associated with the second project;
managing royalties associated with the second project;
managing sales activities associated with the second project;
tracking a status associated with the second project;
generating at least one of an alert and a notification associated with the second project;
generating at least one website to promote the second project; and
generating a communication associated with the second project.

18. The method of claim 1, wherein the online project collaboration comprises interacting via a wiki.

19. The method of claim 1 in a form of a machine-readable medium embodying a set of instructions that, when executed by a machine, causes the machine to perform the method of claim 1.

20. A system, comprising:
a community environment;
a community network module of the community environment, the community network module to include user profiles and project profiles, each project profile of the project profiles associated with at least one user profile of the user profiles and a project;
a privilege level module of the community environment to designate at least one privilege level associated with at least one of a first project profile associated with a first user profile of the user profiles to a second user profile of the user profiles; and
an online project collaboration module of the community environment to generate an online project collaboration between a first project of the project profiles and the second user profile of the user profiles.

21. The system of claim 20, wherein the privilege level module comprises at least one of:
a role-based module of the community environment to designate role-based privilege levels comprising at least one of a reader level, a contributor level, an editor level, and a coeditor level;
a project-based module of the community environment to designate a project-based privilege level comprising at least one of a public level, a private level and a prohibited content level; and
a profile-based module to designate a profile-based privilege level comprising a prohibited user profile level.

22. The system of claim 20, wherein the online project collaboration module comprises at least one of:
a contribution module of the community environment to contribute material to a first project associated with the first project profile;
an edit module of the community environment to edit at least a portion of the first project associated with the first project profile;
a display module of the community environment to display at least a portion of the first project according to a predetermined structure;
a lock module of the community environment to lock at least a portion of the first project associated with the first project profile;
a track module of the community environment to track information associated with the contributed material;
a revision control module of the community environment to control revisions to the first project;
a discussion module of the community environment to enable a discussion associated with at least one of a user profile of the user profiles and a project profile of the project profiles;
a forum module of the community environment to generate a forum to display comments associated with the user profiles and the project profiles;
a messaging module of the community environment to enable messaging associated with at least a portion of the user profiles;
an administration module to manage the online project collaboration;
a partnership module to manage partner-related activities; and
a chat module of the community environment to enable chatting associated with at least a portion of the user profiles.

23. The system of claim 22, wherein the revision control module comprises at least one of:
an archive module of the community environment to archive at least one version of the first project;
a comparison module of the community environment to display at least two versions of the first project and to identify differences between the at least two versions; and
an undo edits module of the community environment to generate a previous version of the first project by reversing edits to a current version of the first project;

24. The system of claim 20, further comprising at least one of:
a community building module of the community environment to generate community building activities;
a user profile module of the community environment to generate personalized user profiles;
a search module of the community environment to generate a search associated with at least one of the user profiles and the project profiles; and
a post-publishing module of the community environment to generate post-publishing activities.

25. The system of claim 24, wherein the community building module comprises at least one of:
a tag module of the community environment to generate tags associated with interest categories;
a topics module of the community environment to generate topics associated with the project profiles;
a project rating module of the community environment to rate a project associated with a project profile;
a user feedback module of the community environment to generate feedback related to a user associated with a user profile of the user profiles; and
a project feedback module of the community environment to generate feedback related to a project associated with a project profile of the project profiles.

26. The system of claim 24, wherein the user profile module comprises at least one of:
a friends network module of the community environment to associate at least one user profile of the user profiles with the first user profile of the user profiles;
a blocked user profile module of the community environment to block at least one user profile of the user profiles;
a favorite projects module of the community environment to generate a list of favorite projects, each favorite project associated with a corresponding project profile of the project profiles;
a customize interface module of the community environment to manage colors and font styles of at least a portion of the community environment; and
a navigation module of the community environment to control a location of a navigational item associated with at least one of a user profile of the user profiles and a project profile of the project profiles.

27. The system of claim 24, wherein the search module comprises at least one of:
a search tags module of the community environment to search tags associated with interest categories;
a search full text module of the community environment to search at least a portion of the user profiles and at least a portion of the project profiles in full text mode; and
a search topics module of the community environment to search the project profiles based on at least one of a topic and a genre.

28. The system of claim 24, wherein the post-publishing module comprises at least one of:
a pricing module of the community environment to generate a price related to a second project associated with a second project profile of the project profiles;
a marketing module of the community environment to determine marketing preferences associated with the second project;
an author pages module of the community environment to generate customized author pages associated with the second project;
an ordering module of the community environment to generate orders associated with the second project;
a royalties module of the community environment to manage royalties associated with the second project;
a sales activities module of the community environment to manage sales activities associated with the second project;
a tracking module of the community environment to track a status associated with the second project;
an alerts module of the community environment to generate at least one of an alert and a notification associated with the second project;
a website module of the community environment to generate at least one website to promote the second project; and
a communication module of the community environment to generate a communication associated with the second project.

29. The system of claim 20, wherein the project comprises at least one of a book, a magazine, audio books, an advertising copy, a screenplay, a periodical, music, video, and a music sound file.

30. The system of claim 29, wherein the book comprises at least one of a section, a chapter, cited material, and quoted material.

31. The system of claim 20, wherein the online project collaboration comprises interacting via a wiki.

32. A community environment, comprising:
a first instruction set to enable a community network, to include a user database to include user profiles and a project database to include project profiles, each project profile associated with at least one user profile of the user profiles and a project;
a second instruction set integrated with the first instruction set to generate privilege levels associated with the user profiles and the project profiles; and
a third instruction set integrated with the first instruction set and the second instruction set to generate an online collaboration between a user profile of the user profiles and a project of a project profile of the project profiles.

33. The community environment of claim 32, further comprising:
a fourth instruction set integrated with the first instruction set and the second instruction set and the third instruction set to generate a display associated with at least one of the online collaboration, the user profile of the user profiles, the project profile of the project profiles and the project.
